(19) United States
(12) Patent Application Publication
(10) Pub. No.: US 2014/0083814 A1
(43) Pub. Date: Mar. 27, 2014

(54) MONEY HANDLING APPARATUS, MONEY HANDLING SYSTEM, MONEY TRANSPORT CASSETTE, BANKNOTE HANDLING APPARATUS AND BANKNOTE HANDLING METHOD

(71) Applicants: Eiichi Nomura, Himeji-shi (JP); Masayuki Akagi, Siso-shi (JP); Kazuhiro Doi, Himeji-shi (JP); Kenichi Tagashira, Himeji-shi (JP); Minoru Higashiyama, Himeji-shi (JP); Keiju Nakagawa, Tatsuno-shi (JP)

(72) Inventors: Eiichi Nomura, Himeji-shi (JP); Masayuki Akagi, Siso-shi (JP); Kazuhiro Doi, Himeji-shi (JP); Kenichi Tagashira, Himeji-shi (JP); Minoru Higashiyama, Himeji-shi (JP); Keiju Nakagawa, Tatsuno-shi (JP)

(73) Assignee: GLORY LTD., Himeji-shi, Hyogo-ken (JP)

(21) Appl. No.: 14/000,698

(22) PCT Filed: Feb. 20, 2012
(86) PCT No.: PCT/JP2012/053978

§ 371 Date: Nov. 25, 2013

(30) Foreign Application Priority Data
Feb. 22, 2011 (JP) 2011-036091
Mar. 25, 2011 (JP) 2011-067955
Sep. 29, 2011 (JP) 2011-214016

(51) Int. Cl. G07D 11/00

(52) U.S. Cl. CPC G07D 11/0027
USPC 194/206

(57) ABSTRACT

A banknote handling apparatus 11 in an embodiment according to the present invention includes: a depositing unit 110 configured to put a banknote thereinto; a storing unit 150 configured to store a banknote; a transport unit 130 configured to transport a banknote from the depositing unit to the storing unit; and a position correcting unit 115 configured to correct a position of a banknote having been put into the depositing unit such that both side edges of the banknote conform to a transport direction of the transport unit.

### TECHNICAL FIELD

The present invention relates to a money handling apparatus, a money handling system, a money transport cassette, a banknote handling apparatus and a banknote handling method.

### BACKGROUND ART

In stores and financial institutions, there has been conventionally used a cash handling apparatus configured to count and store cash having been put thereinto, and to dispense cash stored therein. The cash handling apparatus is generally composed of a banknote handling apparatus and a coin handling apparatus. In accordance with the worldwide prevalence of such a cash handling apparatus, the cash handling apparatus handles various kinds of banknotes including not only Japanese yen banknotes but also foreign banknotes. When the number of kinds of banknotes increases, the banknote handling apparatus constituting the cash handling apparatus is required to smoothly deposit, dispense and store banknotes of different sizes.

It is desirable that each edge of a banknote to be handled in the banknote handling apparatus is perpendicular to or in parallel with a direction in which the banknote is transported.

However, a width of a tray in a depositing unit or a dispensing unit should set to be adapted to a banknote of a maximum size. When such a tray is used, a banknote of a smaller size may be placed in a skewed state relative to a direction in which the banknote is fed from the tray, or may be placed edgewise of the tray. Upon feeding out a banknote, if a banknote is placed in a skewed state, the banknote is fed in a skewed state relative to the transport direction (skewed feed). In addition, when a banknote is placed edgewise of the tray, a feeding unit feeds out the banknote, not by pulling a central portion of the banknote but by pulling a position near to one side of the banknote, which also results in skewed feed. The skewed feed invites a banknote jam in the course of a transport path, or makes it difficult to recognize a banknote.

On the other hand, if a plurality of banknotes in a storing unit are transported in a skewed state to a dispensing unit, edges of the plurality of banknotes are not aligned with each other when the banknotes are dispensed from the dispensing unit. Thus, it is difficult for a user to take out the banknotes from the dispensing unit.

By the way, in financial markets in Europe, when a banknote handling apparatus such as an ATM recognizes a banknote, which has been put thereinto from an outside of a housing, as a counterfeit note or a suspect note, such a banknote must not be returned to a customer but must be taken into the housing of the apparatus, based on the regulation (Article 6) in the European financial markets. When the same regulation as the regulation of the European financial markets is applied to retail markets, the following problem may occur. Namely, many of change machines used in the current retail markets have one inlet/outlet. When a banknote having been put into the change machine from an outside of a housing through the inlet/outlet is recognized as a counterfeit note or a suspect note, the banknote is returned to the inlet/outlet. Thus, the regulation of the European financial markets that a counterfeit note and a suspect note must be taken into the housing cannot be obliged.

A money settlement apparatus and a POS (Point Of Sale) register have been conventionally used in a checkout counter in a store, in order that a clerk sends and receives money to and from a customer. The money settlement apparatus has a function for recognizing and counting money having been put thereinto to calculate a sum thereof, a function for storing the money, and a function for dispensing the money stored therein as change.

On the other hand, in a back office of a store, a money accounting apparatus is used for loading a money settlement apparatus installed in the store with money such as a change fund and the like, or for collecting sales proceeds and the like from the money settlement apparatus. The money accounting apparatus has a function for storing money having been collected from the money settlement apparatus, and a function for dispensing money to be loaded to the money settlement apparatus.

Upon start of store hours, a clerk is generally required to load the money settlement apparatus with a change fund and the like. In addition, after the store hours, a clerk is required to store sales proceeds and the like stored in the money settlement apparatus into the money accounting apparatus in the back office.

In such a change loading process and a change collecting process, the use of a money transport cassette is under review in consideration of security and management burden of a manager.

For example, a cassette disclosed in JP2008-198131A includes a drive source for feeding a banknote stored in the cassette. A banknote handling apparatus has a connector adapted to be connected to the cassette. When the cassette is electrically connected to the connector of the banknote handling apparatus, the banknote handling apparatus drives the drive source of the cassette. Thus, a banknote stored in the cassette is deposited into the banknote handling apparatus.

However, between the money settlement apparatus and the POS register of the check counter in the store, and the money accounting apparatus in the back office, it is necessary to transport money, not only when money is loaded upon start of store hours and when money is collected after the store hours, but also when a cashier changes places with another cashier and when a change is loaded or collected during the store hours. In this case, the money transport cassette is attached to and detached from the money settlement apparatus or the money accounting apparatus (the two apparatuses are hereinafter referred to as “money handling apparatus”) a number of times.

When the number of times at which the money transport cassette is attached to and detached from the money handling apparatus (number of connection times) increases, connectors for electrical connection between the money transport cassette and the money handling apparatus wear out to possibly lead unsuccessful connection therebetween.

Meanwhile, it can be considered that the respective connectors of the money transport cassette and the money handling apparatus are exchanged at regular intervals, taking account of the wear of these connectors. However, since the number of connection times of these connectors is not uniform, a regular exchange cycle is needed to be set at relatively a short term. In this case, a connector that is not connected so many times and thus does not wear is exchanged. Such an operation is inefficient and uneconomic.

The present invention has been made in view of the above circumstances. The object of the present invention is to provide a money handling apparatus capable of, when banknotes of various sizes are put thereinto in a skewed state or in a biased state, making suitable orientations of the banknotes with respect to a transport direction, while restraining banknote jam during transportation and facilitating recognition of the banknotes.

In addition, the object of the present invention is to provide a money handling system, a money transport cassette and a money handling apparatus capable of preventing unsuccessful electric connection between the money transport cassette and the money handling apparatus, by suitably exchanging respective connectors of the money transport cassette and the money handling apparatus depending on the number of connection times of the connector.

Further, the object of the present invention is to provide a banknote handling apparatus and a banknote handling method capable of, when a banknote having been put to an inside of a housing from an outside thereof is recognized as a counterfeit note or a suspect note, not returning the banknote to the outside of the housing.
JP4292232B
JP58-22240A
JP4-41335A
JP2008-198131A
JP2007-058285A
EP1598787A2

### DISCLOSURE OF THE INVENTION

A money handling machine in an embodiment of the present invention includes: a depositing unit configured to put a banknote thereinto; a storing unit configured to store the banknote; a transport unit configured to transport the banknote from the depositing unit to the storing unit; and a position correcting unit configured to correct a position of the banknote having been put into the depositing unit, such that a direction of both side edges of the banknote approximates a transport direction of the transport unit, the side edges of the banknote longitudinally expanding with respect to a transport direction.

The money handling machine may further includes a banknote placement unit configured to place thereon the banknote having been put into the depositing unit, wherein the position correcting unit may be configured to correct the position of the banknote having been put into the depositing unit, such that a middle of the both side edges of the banknote approximates a middle of the banknote placement unit.

The position correcting unit may align a plurality of banknotes having been put into the depositing unit, such that the both side edges of the banknotes substantially conform to each other, when the banknotes having been put into the depositing unit are viewed from above surfaces thereof.

The position correcting unit may include: at least one guide being movable substantially perpendicular to the transport direction of the transport unit, in a substantial horizontal plane with respect to a surface of the banknote having been put into the depositing unit; a drive source configured to move the guide such that the guide elastically pushes the side edge of the banknote; and a transmission mechanism configured to transmit a drive force of the drive source to the guide through an elastic member.

The depositing unit may include a sensor configured to detect the banknote having been put thereinto or dispensed; and the position correcting unit may be configured, when the sensor detects the banknote, to correct a position of the banknote.

The money handling apparatus according to claim 1 may further include a dispensing unit configured to dispense the banknote, wherein: the transport unit may be configured to transport the banknote from the storing unit to the dispensing unit; and the dispensing unit may include a position correcting unit configured to correct a position of the banknote having been dispensed to the dispensing unit, such that a direction of the both side edges of the banknote approximates the transport direction of the transport unit, the side edges of the banknote longitudinally expanding with respect to a transport direction.

A money handling system in an embodiment of the present invention includes a money handling apparatus configured to deposit or dispense money, and a money transport cassette attachable to and detachable from the money handling apparatus in order to transport money so as to deposit the money to the money handling apparatus or to dispense the money from the money handling apparatus, wherein the money handling apparatus includes: a first connection unit to be connected to the money transport cassette, when the money transport cassette is attached to the money handling apparatus; a first memory unit configured to store a first number of connection times showing how many times the money transport cassette had been connected to the first connection unit; and a control unit configured to increase the first number of connection times, when the money transport cassette is connected to the first connection unit.

The money transport cassette may include: a second connection unit coupled to the first connection unit to be connected to the money handling apparatus, when the money transport cassette is attached to the money handling apparatus; and a second memory unit configured to store a second number of connection times showing how many times the second connection unit has been connected to the money handling apparatus.

The money handling apparatus may further include a reading/writing unit configured to read out the second number of connection times of the money transport cassette, when the money transport cassette is connected to the first connection unit; the control unit may be configured to increase the second number of connection times having been read out by the reading/writing unit; and the reading/writing unit may be configured to rewrite the increased second number of connection times to the second memory unit.

The second memory unit of the money transport cassette may be configured to store the second number of connection times and cassette identification information assigned to the money transport cassette; the reading/writing unit of the money handling apparatus may be configured to read out the second number of connection times and the cassette identification information, when the money transport cassette is connected to the first connecting unit; and the first memory unit may be configured to store the second number of connection times corresponding to the money transport cassette and the cassette identification information corresponding thereto, such that the second number of connection times and the cassette identification information are correlated to each other.

The money handling system may further include a management apparatus communicably connected to the money handling apparatus, and configured to store the first number of connection times and the second number of connection times.

The money handling apparatus may further include a notification unit configured to notify that, when the first or the second number of connection times reaches a predetermined value, the first or the second number of connection times has reached the predetermined value.

The money handling system may be configured to notify that, when the first or the second number of connection times reaches a predetermined value, the first or the second number of connection times has reached the predetermined value, to the management apparatus.

If the first or the second number of connection times has reached a predetermined value when the money transport cassette is connected to the first connection unit, the money handling apparatus may not deposit and dispense money to and from the money transport cassette.

The control unit may be configured to set an upper limit value of the first or the second number of connection times, or the money handling system may include a connection-times setting apparatus configured to set an upper limit value of the first or the second number of connection times.

A money transport cassette in an embodiment of the present invention, which is attachable to and detachable from a money handling apparatus in order to transport money so as to deposit the money to the money handling apparatus or to dispense the money from the money handling apparatus, includes: a connection unit to be connected to the money handling apparatus, when the money transport cassette is attached to the money handling apparatus; and a memory unit configured to store a number of connection times showing how many times the connection unit has been connected to the money handling apparatus.

The memory unit may be configured to store the number of connection times and cassette identification information assigned to the money transport cassette.

A money handling apparatus in an embodiment of the present invention, to which a money transport cassette configured to transport money is attachable or from which the money transport cassette is detachable in order to deposit or dispense money, includes: a first connection unit configured to connected to the money transport cassette, when the money transport cassette is attached to the money handling apparatus; a first memory unit configured to store a first number of connection times showing how many times the money transport cassette has been connected to the first connection unit; and a control unit configured to increase the first number of connection times, when the money transport cassette is connected to the first connection unit.

The money handling apparatus may further include a reading/writing unit configured to read out a second number of connection times showing how many times the money transport cassette has been connected to the money handling apparatus, from a second memory unit disposed on the money transport cassette, when the money transport cassette is connected to the first connection unit; the control unit may be configured to increase the second number of connection times having been read out by the reading/writing unit; and the reading/writing unit may be configured to rewrite the increased second number of connection times to the second memory unit.

The reading/writing unit may be configured to read out the second number of connection times and cassette identification information assigned to the money transport cassette, from the money transport cassette, when the money transport cassette is connected to the first connection unit; and the first memory unit may be configured to store the second number of connection times corresponding to the money transport cassette and the cassette identification information corresponding thereto, such that the second number of connection times and the cassette identification information are correlated to each other.

The money handling apparatus may further includes a notification unit configured to notify that, when the first or the second number of connection times reaches a predetermined value, the first or the second number of connection times has reached the predetermined value.

The money handling apparatus may be configured not to deposit and dispense money to and from the money transport cassette, if the first or the second number of connection times has reached a predetermined value when the money transport cassette is connected to the first connection unit.

The control unit may be configured to set an upper limit value of the first or the second connection times.

A banknote handling apparatus in an embodiment of the present invention includes: a housing; an inlet configured to put a banknote from an outside into the housing; a transport unit disposed in the housing, and configured to transport, one by one, the banknote having been put into the housing through the inlet; a recognition unit disposed on the transport unit, and configured to recognize at least an authenticity of the banknote having been put into the housing through the inlet; and a control unit configured to control the transport unit such that, when the banknote is recognized as not genuine by the recognition unit, the banknote is not returned to the outside of the housing.

The control unit may be configured to control the transport unit such that, when the banknote is recognized as not genuine by the recognition unit, the transport of the banknote by the transport unit is stopped.

A storing unit configured to store the banknote having been put into the housing through the inlet may be disposed in the housing; and the control unit may be configured to control the transport unit such that, when the banknote is recognized as not genuine by the recognition unit, the banknote is transported to the storing unit so as to be stored in the storing unit.

The control unit may be configured to control the transport unit such that, after the banknote having been recognized as not genuine by the recognition unit has been stored into the storing unit, the transport of the banknote by the transport unit is stopped.

A banknote stop location may be provided on a position that is inaccessible from the outside of the housing, the banknote having been recognized as not genuine by the recognition unit is stopped at the banknote stop location; and the control unit may be configured to control the transport unit such that, when the banknote is recognized as not genuine by the recognition unit, the banknote is transferred to the banknote stop location.

A plurality of the banknote stop locations may be provided, and the control unit may include a stop-location selecting unit configured to select, when the banknote is recognized as not genuine by the recognition unit, one of the banknote stop locations at which the banknote is to be stopped.

The banknote handling apparatus may further include a notification unit configured to notify that, when the banknote is recognized as not genuine by the recognition unit, the banknote has been recognized as not genuine by the recognition unit.

The notification unit may be configured to notify a stop position of the banknote having been recognized as not genuine by the recognition unit in the housing and/or recognized information of the banknote recognized by the recognition unit.

The banknote handling apparatus may further include an operation unit configured to, when the notification unit notifies that the banknote has been recognized as not genuine by the recognition unit, input as to whether the banknote is taken into the housing or not.

The inlet may be configured to also function as an outlet configured to dispense the banknote from the inside of the housing to the outside thereof.

An outlet configured to dispense the banknote from the inside of the housing to the outside thereof may be provided separately from the inlet.

The banknote handling apparatus may be a manned change machine, an unmanned change machine or a back office machine.

A banknote handling method in an embodiment of the present invention includes: putting a banknote from an outside of a housing to an inside thereof; and recognizing at least an authenticity of the banknote having been put into the housing, wherein, when the banknote is recognized as not genuine in recognizing at least the authenticity of the banknote, the banknote is not returned to the outside of the housing.

When the banknote is recognized as not genuine in recognizing at least the authenticity of the banknote, transport of the banknote in the housing may be stopped.

When the banknote is recognized as not genuine in recognizing at least the authenticity of the banknote, the banknote may be transported to a storing unit disposed in the housing so as to be stored into the storing unit.

After the banknote having been recognized as not genuine has been stored into the storing unit, the transport of the banknote in the housing may be stopped.

### BRIEF DESCRIPTION OF THE DRAWINGS

FIG. 1 is a block view showing a structural example of a money management system 1 in accordance with a first embodiment.

FIG. 2 is a view showing an appearance of an example of a money settlement apparatus 11.

FIG. 3 is a block view showing a structural example of the money settlement apparatus 11.

FIG. 4 is a sectional view showing an example of an inside structure of a banknote settlement apparatus 12.

FIG. 5 is a sectional view showing an example of an inside structure of a coin settlement apparatus 13.

FIG. 6 is a view showing an appearance of an example of money accounting apparatus 21.

FIG. 7 is a block view showing a structural example of the money accounting apparatus 21.

FIG. 8 is a sectional view showing an inside structure of a banknote accounting apparatus 22.

FIG. 9 is a sectional view showing an example of an inside structure of a coin accounting apparatus 23 of the money accounting apparatus 21.

FIG. 10 is a structural view showing an example of a position correcting unit 115 in the first embodiment.

FIG. 11 is a conceptual view showing an example of a banknote position correcting operation.

FIG. 12 is a side view of the position correcting unit 115 when viewed from a lateral side.

FIG. 13 is a flowchart showing a depositing operation of a banknote change machine 11 in the first embodiment.

FIG. 14 is an outline view showing a structural example of a money transport cassette 30 of a tape reeling type, which is configured to transport a banknote, in a second embodiment.

FIG. 15 is an outline view showing a structural example of the money transport cassette 30 configured to transport a coin.

FIG. 16 is a view showing a structure of a connector 192 (or 292) as a first connector and a structure of a connector 39 as a second connector.

FIG. 17 is a flowchart showing an operation of a money handling system 1 in a second embodiment.

FIG. 18 is a flowchart showing an exchanging operation of connectors in the second embodiment.

FIG. 19 is a flowchart showing another operation of the money handling system 1 in the second embodiment.

FIG. 20 is a flowchart showing an operation of a banknote change machine 12 in a third embodiment.

FIG. 21 is a flowchart showing an operation of the banknote change machine 12 in the third embodiment.

### DETAILED DESCRIPTION

Embodiments of the present invention will be described herebelow with reference to the drawings. These embodiments do not limit the present invention.

### First Embodiment

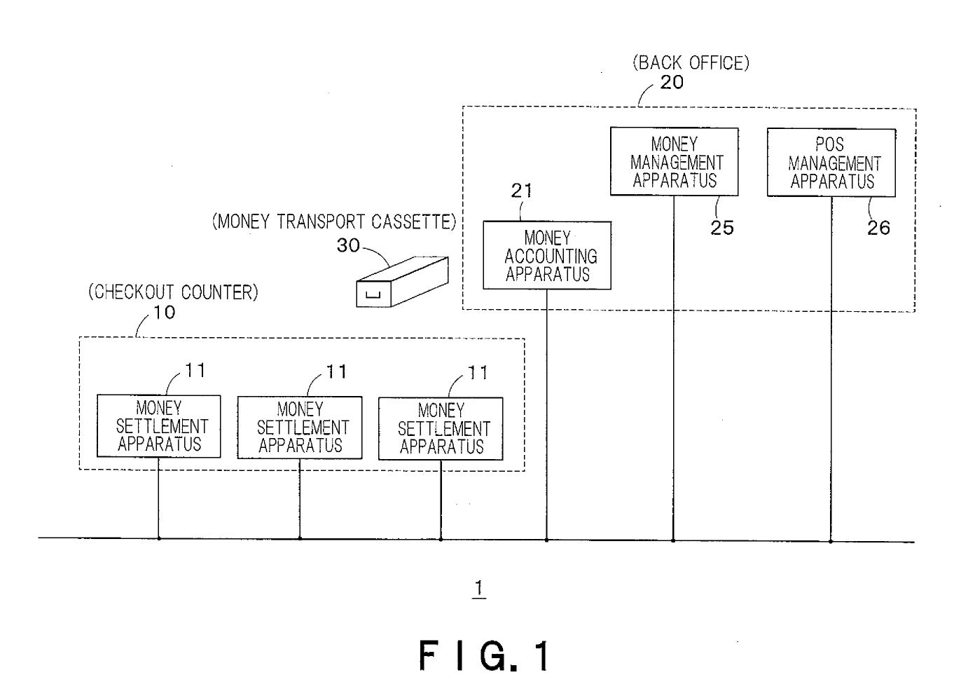

FIG. 1 is a block view showing a structural example of a money management system 1 in accordance with a first embodiment of the present invention. The money management system 1 is a system configured to handle and manage money received by a clerk from a customer and money to be paid from a clerk to a customer.

The money management system 1 is installed in a checkout area in a store. The money management system 1 is composed of a checkout counter 10 where money received by a clerk from a customer is deposited and money to be paid from the clerk to the customer is dispensed, a back office 20 where money of the checkout counter 10 and commercial products are managed, and a money transport cassette 30 configured to transport money between the checkout counter 10 and the back office 20.

The checkout counter 10 is provided with one or more money settlement apparatuses configured to perform a settlement process with respect to a customer by depositing and dispensing money. In FIG. 1, the checkout counter 10 is provided with the three money settlement apparatuses 11. Each money settlement apparatus 11 is operated by a clerk or a customer himself/herself to be used for a settlement process between the clerk and the customer. For example, the money settlement apparatus 11 deposits payment paid by a customer, and dispenses change to be paid to the customer.

The money settlement apparatus 11 is communicably connected to a POS register operated by a clerk or a self-checkout register operated by a customer, for example. The money settlement apparatus 11 may be integrally formed with the POS register or the self-checkout register.

The back office 20 is provided with a money accounting apparatus 21, a money management apparatus 25 and a POS management apparatus 26. The money accounting apparatus is communicably connected to the money settlement apparatuses 11, and is configured to dispense a change fund to be loaded to the money settlement apparatuses 11 and to deposit sales proceeds collected from the money settlement apparatuses 11. The money management apparatus 25 is communicably connected to the money settlement apparatuses 11 and the money accounting apparatus 21 through a LAN (Local Area Network) or the like. The money management apparatus 25 is configured to manage money stored in the money settlement apparatuses 11 and the money accounting apparatus 21. For example, the money management apparatus 25 is configured to manage money having been settled in the respective money settlement apparatuses 11, and money transferred between each money settlement apparatus 11 and the money accounting apparatus 21. In addition, the money management apparatus 25 may monitor whether the money transport cassette 30 is attached to the money settlement apparatus 11 or the money accounting apparatus 21. The POS management apparatus 26 is configured to manage a flow of commercial products. Since the flow of commercial products is not directly related to the present invention, detailed description of the POS management apparatus 26 is omitted.

The money transport cassette 30 can be attached to and detached from the money settlement apparatus 11 and the money accounting apparatus 21. When attached to the money settlement apparatus 11 or the money accounting apparatus 21, the money transport cassette 30 can transfer money between the money transport cassette 30 and the money settlement apparatus 11, or between the money transport cassette 30 and the money accounting apparatus 21. On the other hand, when detached from the money settlement apparatus 11 and the money accounting apparatus 21, the money transport cassette 30 stores money therein such that the money cannot be taken out therefrom. A clerk uses the money transport cassette 30 to transport money between the money settlement apparatus 11 and the money accounting apparatus 21. For example, when a change fund is loaded or when sales proceeds are collected, a clerk uses the money transport cassette 30 to transport money between the money settlement apparatus 11 and the money accounting apparatus 21. Since the clerk cannot touch the money in the money transport cassette 30 during the money transportation, the money can be safely transported in terms of security.

The money transport cassette 30 may be configured to transport any one of a banknote and a coin, or to transport both a banknote and a coin. The money transport cassette 30 for banknote may be a stacking-type cassette in which banknotes are stacked on one another, or may be a tape reeling-type cassette in which banknotes, which are sandwiched one by one between a pair of elongate tapes, are reeled up together with the tapes. The money transport cassette 30 for coin may be a cassette configured to store coin in a denomination mixed state.

(Structure of Money Settlement Apparatus 11)

Each of the money settlement apparatuses 11 includes a coin settlement apparatus 13 configured to perform a settlement process by depositing and dispensing a coin, and a banknote settlement apparatus 12 configured to perform a settlement process by depositing and dispensing a banknote.

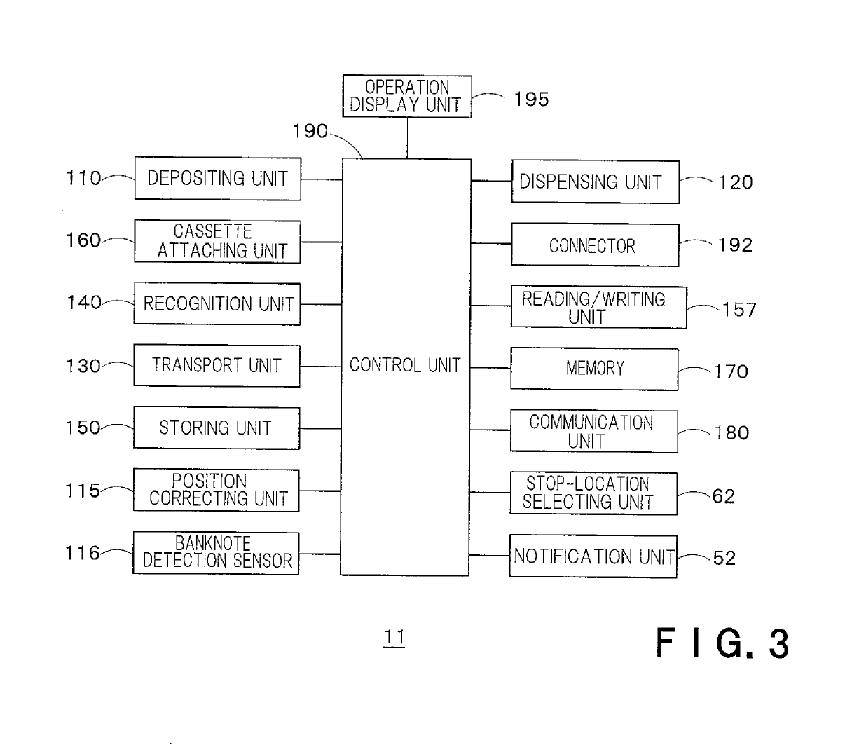

Herebelow, in order to differentiate constituent elements of the banknote settlement apparatus 12 and constituent elements of the coin settlement apparatus 13 from each other, a character “a” is added to a reference number of a constituent element of the banknote settlement apparatus 12, and a character “b” is added to a reference number of a constituent element of the coin settlement apparatus 13. Since the objects (a coin and a banknote) to be handled by the coin settlement apparatus 13 and the banknote settlement apparatus 12 differ from each other, the coin settlement apparatus 13 and the banknote settlement apparatus 12 differ from each other in concrete structures thereof. However, the basic block structure shown in FIG. 3 is common thereto.

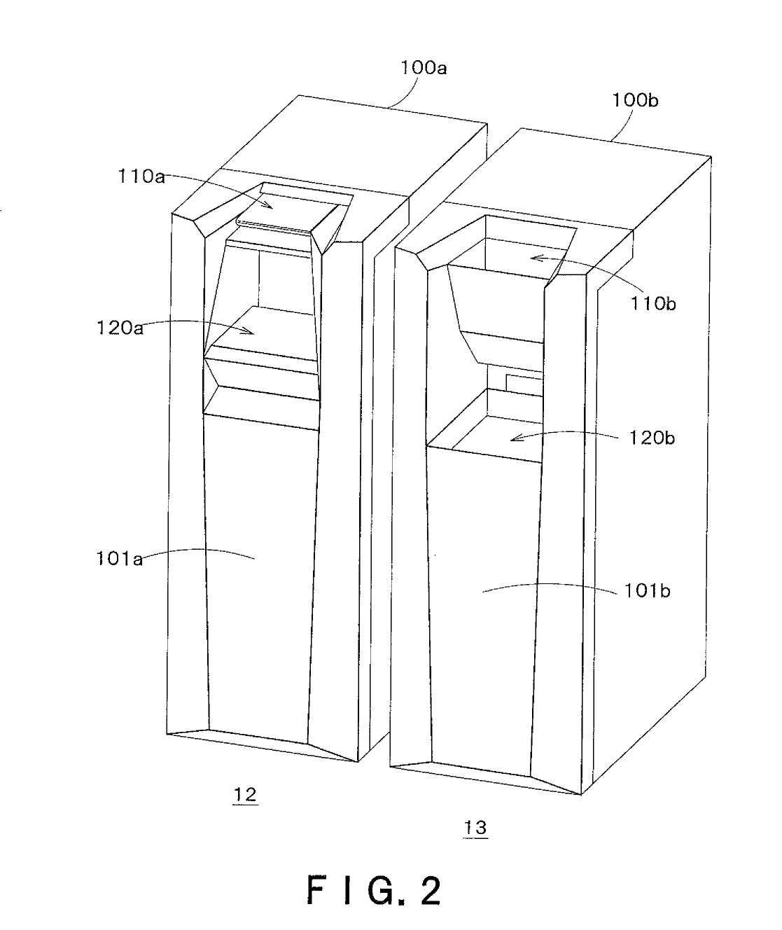

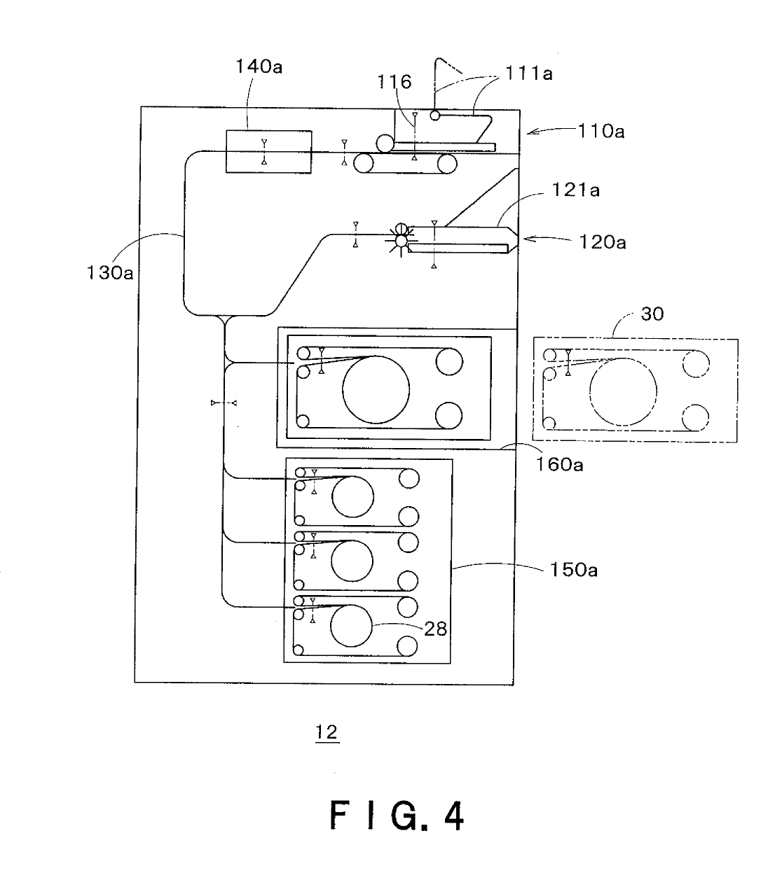

FIG. 2 is a view showing an appearance of an example of each money settlement apparatus 11. The money settlement apparatus 11 includes the banknote settlement apparatus 12 and the coin settlement apparatus 13. The banknote settlement apparatus 12 has a housing 100a, a depositing unit 110a and a dispensing unit 120a. The depositing unit 110a is provided for putting a banknote(s) received by a customer thereinto. The dispensing unit 120b is provided for dispensing a change banknote(s). When a front cover 101a of the housing 100a is opened, there is a cassette attaching unit (see 160a of FIG. 4) to which the money transport cassette 30 is attached.

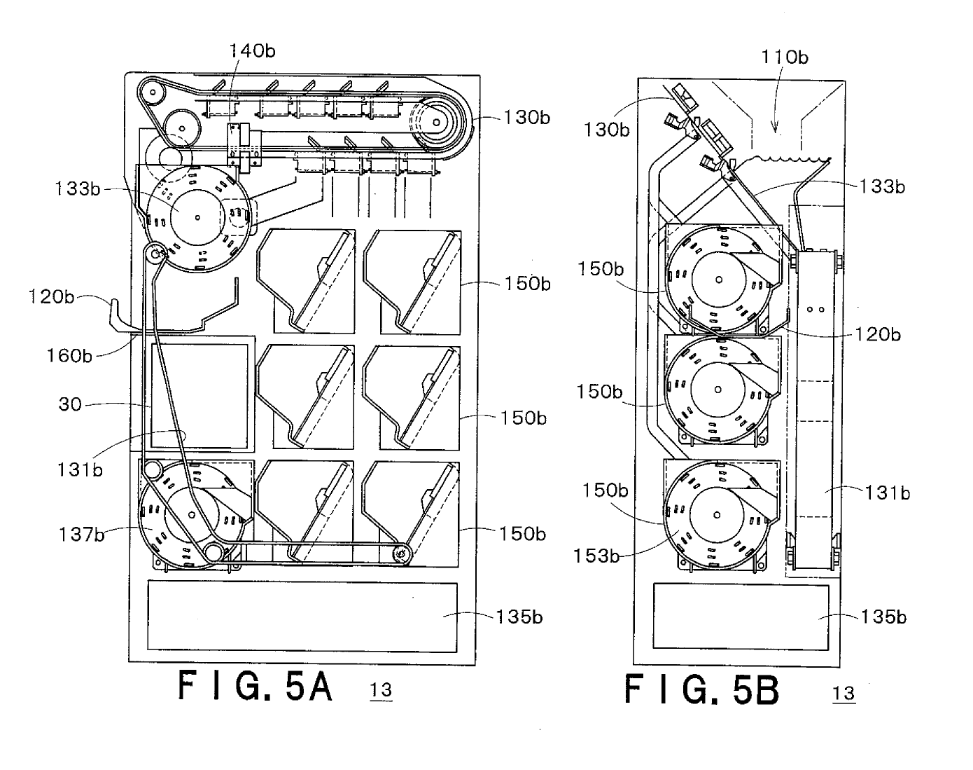

The coin settlement apparatus 13 has a housing 100b, a depositing unit 110b and a dispensing unit 120b. The depositing unit 110b is provided for putting a coin(s) received by a customer thereinto. The dispensing unit 120b is provided for dispensing a change coin(s). When a front cover 101b of the housing 100b is opened, there is a cassette attaching unit (see 160b in FIG. 5) on which the money transport cassette 30 is attached.

FIG. 3 is a block view showing a structural example of the money settlement apparatus 11. In addition to the depositing unit 110 and the dispensing unit 120, the money settlement apparatus 11 further includes a transport unit 130, a recognition unit 140, a storing unit 150, a reading/writing unit 157, a cassette attaching unit 160, a memory 170, a communication unit 180, a control unit 190, a connector 192 and an operation display unit 195.

The transport unit 130 is configured to transport money having been put into the depositing unit 110 to the storing unit 150, or to transport money, which is to be dispensed from the dispensing unit 120, from the storing unit 150. In addition, the transport unit 130 is configured to transport money in the money transport cassette 30, which is attached to the cassette attaching unit 160, to the storing unit 150, in order that the money is loaded to the storing unit 150, or to transport money stored in the storing unit 150 to the money transport cassette 30, in order that the money is collected from the storing unit 150.

The recognition unit 140 is configured to detect a denomination, an authenticity (and a suspicion about authenticity), a fitness, a version, an amount and so on of cash being transported by the transport unit 130. For example, the recognition unit 140 has a sensor such as an image sensor or a magnetic sensor. To be specific, the recognition unit 140 is configured to judge a denomination, an authenticity (and a suspicion about authenticity), a fitness, a version, an amount and so on of the banknotes, by comparing sensor information with information stored in the memory 170, so as to sort the banknotes into a genuine note, a counterfeit note and a suspect note. A banknote whose denomination could not be recognized is judged as a reject note. In addition, the recognition unit 140 is configured to detect a folded state, a torn state and a stain of a banknote, so as to sort banknotes to a fit note in a good condition and an unfit note in a bad condition. In addition, the recognition unit 140 is configured to count an amount of cash by denomination and fitness.

Banknote detection sensors 116 are disposed on the depositing unit 110, the dispensing unit 120 and the transport unit 130 and so on, and are configured to detect presence of a banknote and passage of a banknote being transported.

The storing unit 150 is configured to store, by denomination, money having been recognized by the recognition unit 140. When the storing unit 150 stores banknotes, the storing unit 150 may be a stacking-type storing unit in which banknotes are stacked on one another by denomination, or may be a tape reeling-type storing unit in which banknotes, which are sandwiched by denomination between a pair of elongate tapes, are reeled up together with the tapes.

The cassette attaching unit 160 is configured such that the money transport cassette 30 can be attached thereto and detached therefrom. The cassette attaching unit 160 is configured to deposit money from the money transport cassette 30 or to dispense money to the money transport cassette 30.

The reading/wiring unit 157 is configured to read out information stored in a below-described memory unit 35 disposed on the money transport cassette 30, or to write information to the memory unit 35.

The connector 192 is configured to be connected to the money transport cassette 30, when the money transport cassette 30 is attached to the money settlement apparatus 11.

The memory 170 includes various programs for controlling the money settlement apparatus 11, a ROM (Read Only Memory) or a HDD (Hard Disk Drive) storing data, and a RAM (Random Access Memory) serving as a program loading area or a working area when a program is executed, and so on. The memory 170 also stores information (a denomination, an amount and so on) of money stored in the storing unit 150 and the money transport cassette 30. In addition, the memory 170 stores the number of connection times showing how many times the money transport cassette 30 is connected to the connector 192. Further, the memory 170 may store, by denomination, an amount of money having been recognized by the recognition unit 140.

The communication unit 180 is communicably connected to other apparatuses (money accounting apparatus 21, money management apparatus 25, POS management apparatus 26) constituting the money handling system 1.

The control unit 190 is a processing unit configured to execute a program in the memory 170 to control the money settlement apparatus 11 as a whole. When the money transport cassette 30 is connected to the connector 192, the control unit 190 is configured to increase the number of connection times stored in the memory 170, and thereafter to rewrite the increased number of connection times to the memory 170. Further, the control unit 190 is configured to increase the number of connection times stored in the memory unit 35 of the money transport cassette 30, which has been read out by the reading/writing unit 157, and thereafter to rewrite the increased number of connection times to the memory unit 35 through the reading/writing unit 157.

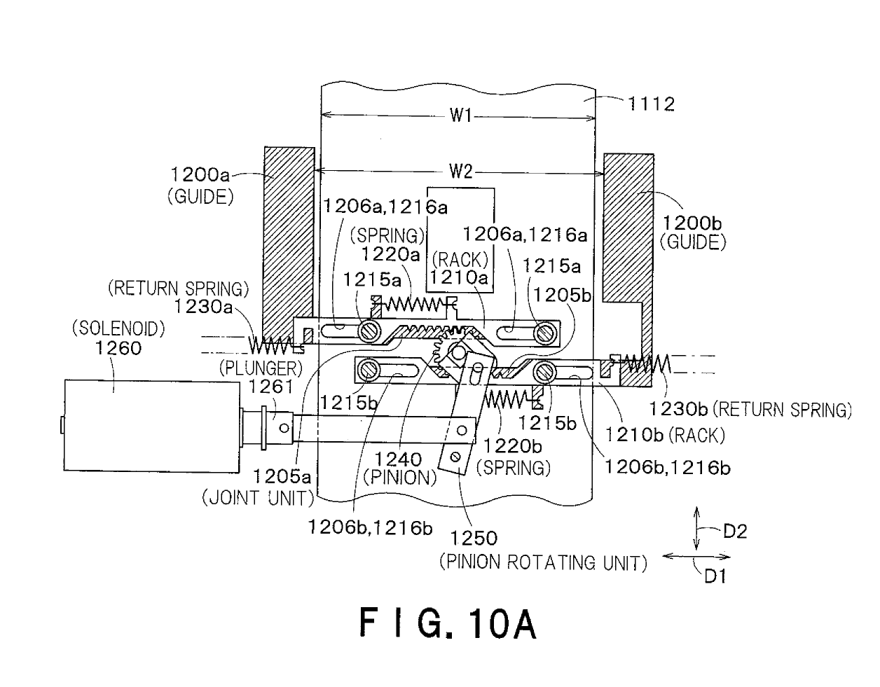

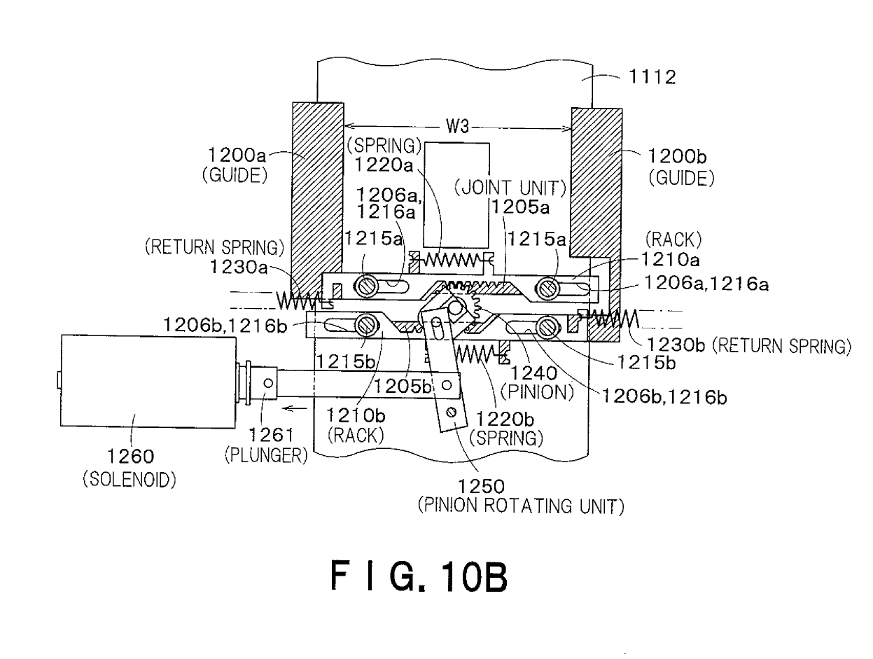

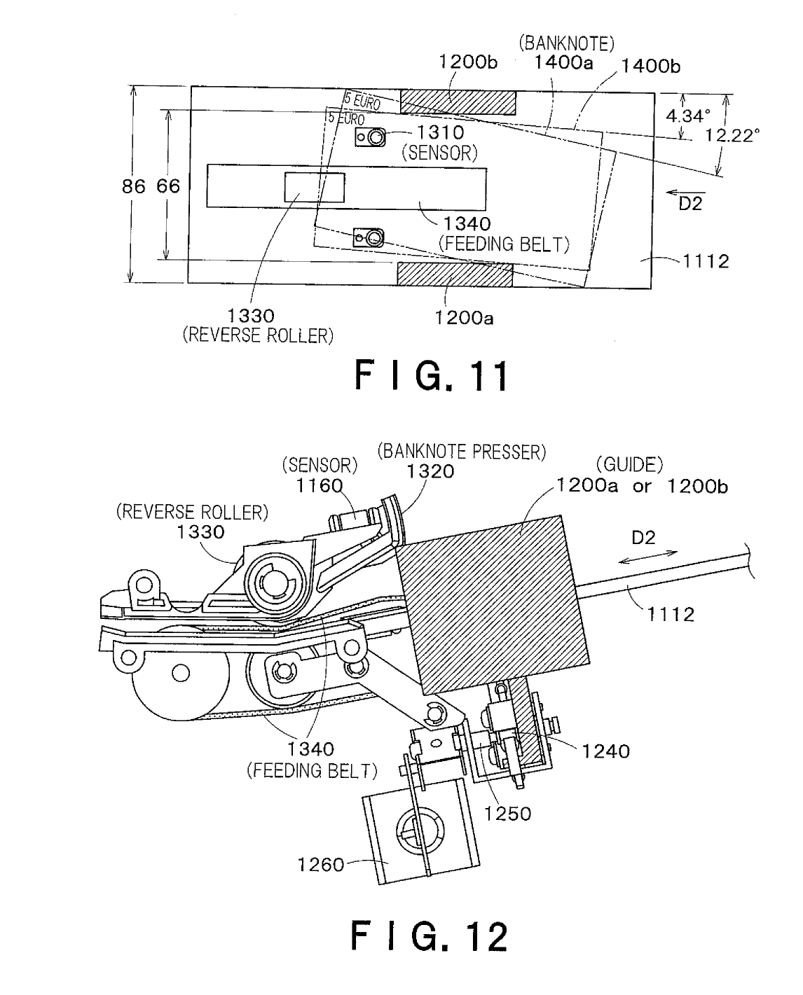

Thus, a degree of wear of the connector 192 and the connector 39 of the money transport cassette 30 (see FIG. 10A and FIG. 11) can be detected, whereby the connectors 192 and 39 can be exchanged at suitable timings.

The operation unit 195 is used when an operator gives various commands to the control unit 190. Specifically, the operation unit 195 is formed of a touch panel and an operation key disposed on a front surface or an upper surface of the housing 100a of the banknote handling apparatus 12, for example. The operation unit 195 may be disposed on another apparatus (21, 25, 26) connected for communication with the banknote handling apparatus 12.

When the money handling apparatus 11 is subjected to maintenance services, the operation display unit 195 can display information such as an ID of the money handling apparatus 11, an ID of the money transport cassette 30, the number of connection times of the connector 192, the number of connection times of the connector 39, a time of day, etc. The information may be displayed on a display unit of the money management apparatus 25. The money management system 1 may further include a printer for printing contents displayed by the operation display unit 195.

In addition, the position correcting unit 115, the banknote detection sensors 116, a notification unit 52, and a stop-location selecting unit 62 are connected to the control unit 190. The notification unit 52 is configured to notify an operator of various information by voice or display, for example. To be specific, the notification unit 52 is formed of a monitor or the like disposed on the front surface or the upper surface of the housing 100a of the banknote handling apparatus 12, for example. The notification unit 52 may be disposed on another apparatus (21, 25, 26) connected for communication with the banknote handling apparatus 12.

The memory 170 is configured to store banknote handling condition and the like in the banknote handling apparatus 12. Specifically, the memory 170 is configured to store the number of banknotes, which are stored in respective storing/feeding units 28, and a sum thereof by denomination, and/or the number of banknotes transported to the money transport cassette 30 and a sum thereof by denomination. The memory 170 may be disposed on another apparatus (21, 25, 26) connected for communication with the banknote handling apparatus 12.

The position correcting unit 115 is disposed on the depositing unit 110 for correcting a position of a banknote having been put into the depositing unit 110. A structure and an operation of the position correcting unit 115 will be described below.

The banknote detection sensor 116 is configured to detect presence of a banknote and passage of a banknote being transported.

FIG. 4 is a sectional view showing an example of an inside structure of the banknote settlement apparatus 12 of the money settlement apparatus 11. The banknote settlement apparatus 12 includes a depositing-unit cover 111a. When a banknote(s) is deposited, a clerk opens the depositing-unit cover 111a and puts a banknote(s) into the depositing unit 110a. The depositing unit 110a is configured to feed the banknotes having been put thereinto, one by one, to the transport unit 130a. Even when the depositing-unit cover 111a is closed, a few banknotes can be deposited into the depositing unit 110a. The transport unit 130a is configured to cause the fed banknotes to pass through the recognition unit 140a, and then to transport the banknotes to the storing unit 150a, the money transport cassette 30 or the dispensing unit 120a. The recognition unit 140a is configured to recognize a denomination, an authenticity, a fitness, a version, an amount and so on of each of the banknotes being transported. The recognition unit 140a has a sensor such as a line sensor or a magnetic sensor. The recognition unit 140a may be provided with an imaging camera, and an image of a banknote may be taken by the imaging camera. In this case, a serial number or the like of the banknote is read out by the recognition unit 140a from the image of the banknote having been taken by the imaging camera. The transport unit 130a stores banknotes by denomination into the storing unit 150a, based on the recognition result by the recognition unit 140a. Banknotes having been put into the housing 100b from the depositing unit 110a are sorted by the recognition unit 140a to a genuine note, a counterfeit note and a suspect note about authenticity.

When the storing unit 150a is full and so on, the transport unit 130a may transport a banknote to the money transport cassette 30 according to need. In addition, when a banknote could not be recognized by the recognition unit 140a or when a banknote was recognized as a counterfeit note, the transport unit 130a is configured to transport the banknote to the dispensing unit 120a. In addition, when a banknote was recognized as a reject note, a counterfeit note or a suspect note by the recognition unit 140a, the transport unit 130 is configured to transport the banknote to the dispensing unit 120. When a counterfeit note and a suspect note are included, a dispensing-unit shutter 121 is maintained to be closed until an operator arrives.

On the other hand, in order to dispense a banknote(s), the storing unit 150a is configured to feed banknotes, one by one, to the transport unit 130a. The transport unit 130a transports the fed banknotes to the dispensing unit 120a. The banknote settlement apparatus 12 is provided with a dispensing-unit shutter 121a. When a banknote is dispensed, the banknote settlement apparatus 12 opens the dispensing-unit shutter 121a and dispenses a banknote. Thus, an operator can take out banknotes stacked in the dispensing unit 120a.

In this manner, the banknote settlement apparatus 12 can store a banknote having been put into the depositing unit 110a, into the storing unit 150a, and can reversely send a banknote stored in the storing unit 150a to the dispensing unit 120a. Namely, the banknote settlement apparatus 12 is configured to reuse a banknote having been deposited thereinto, as a banknote to be dispensed. For example, the storing unit 150 has a plurality of storing/feeding units 28 which are connected to the transport unit 130a. The respective storing/feeding units 28 are configured to store, by denomination, banknotes having been put into the housing 100 from the depositing unit 110a and recognized by the recognition unit 140a. More specifically, based on a recognition result by the recognition result by the recognition unit 140a, banknotes are sent by denomination to the respective storing/feeding units 28 by the transport unit 130a. In addition, each of the storing/feeding units 28 is configured to feed, one by one, banknotes stored therein to the transport unit 130a. Each storing/feeding unit 28 may be a tape reeling-type unit in which banknotes, which are sandwiched one by one between a pair of elongate tapes, are reeled up together with the tapes, or may be a stacking-type unit in which banknotes are stacked on one another (not shown).

As shown in FIG. 4, the money transport cassette 30 can be detachably attached to the housing 100. When the money transport cassette 30 is attached to the housing 100, a banknote can be transported from the transport unit 130a to the money transport cassette 30.

The banknote detection sensors 116 are disposed on the depositing unit 110a, the dispensing unit 120a, respective transport paths in the transport unit 130a, the storing/feeding units 28, the money transport cassette 30, respectively. The banknote detection sensors 116 are configured to detect presence of a banknote and passage of a banknote being transported.

When the money transport cassette 30 is attached to the cassette attaching unit 160a, the banknote settlement apparatus 12 can load a banknote from the money transport cassette 30 to the storing unit 150, or can collect a banknote from the storing unit 150a to the money transport cassette 30. The money transport cassette 30 may be a cassette of a tape reeling type in which banknotes, which are sandwiched one by one between a pair of elongate tapes, are reeled up together with the tapes. When a banknote(s) is loaded, the money transport cassette 30 feeds banknotes, one by one, to the transport unit 130a. The transport unit 130a loads fed banknotes to the storing unit 150a. When a banknote(s) is collected, the storing unit 150a feeds banknotes, one by one, to the transport unit 130a. The transport unit 130a collects the fed banknotes to the money transport cassette 30.

In this manner, the banknote settlement apparatus 12 is configured to load and collect a banknote(s) by using the money transport cassette 30. The money transport cassette 30 can be also detachably attached to the accounting apparatus 21 installed in the back office, whereby cash can be transferred by the money transported cassette 30 between the banknote settlement apparatus 12 and the accounting apparatus 21. When the money transport cassette is detached from the banknote settlement apparatus 12 or the accounting apparatus 21, a banknote stored in the money transport cassette 30 cannot be taken out therefrom.

FIGS. 5A and 5B are sectional views showing an example of an inside structure of the coin settlement apparatus 13 of the money settlement apparatus 11. FIG. 5A is the sectional view of the coin settlement apparatus 13 when viewed from a lateral side, and FIG. 5B is the sectional view of the coin settlement apparatus when viewed from a front side. In FIG. 5B, illustration of the money transport cassette 30 and the feeding unit 137b is omitted, but the storing units 150b are illustrated.

As shown in FIG. 5B, the coin settlement apparatus 13 includes the depositing unit 110b. When a coin(s) is deposited, a clerk puts a coin(s) into the depositing unit 110b. At this time, a plurality of coins may be put thereinto in a denomination mixed state. A centrifugal disk-type feeding unit 133b is configured to feed, one by one, coins having been put into the depositing unit 110b, to the transport unit 130b. The transport unit 130b is configured to cause the fed coins to pass through the recognition unit 140b, and then to transport the coins to the storing unit 150b, the money transport cassette 30 or the dispensing unit 120b. The recognition unit 140b is configured to recognize a denomination, an authenticity, a fitness, a version, an amount and so on of each of the coins being transported. The transport unit 130b sorts the coins by denomination based on the recognition result by the recognition unit 140b, and stores a coin into the storing unit 150b of a corresponding denomination.

When the storing unit 150b is full and so on, the transport unit 130b may transport a coin to the money transport cassette 30 or the collection box 135b according to need. When a coin was recognized as a reject coin by the recognition unit 140b, the transport unit 130b is configured to send the reject coin to the dispensing unit 120b.

On the other hand, in order to dispense a coin(s), the storing unit 150b is configured to feed coins, one by one, to the transport unit 131b. The plurality of storing units 150b store money by denomination, and each of which has a centrifugal disk-type feeding unit 153b. The feeding unit 153b is configured to feed coins, one by one, to the transport unit 130b. The transport unit 130b transports the fed coins to the dispensing unit 120b. Thus, the coin settlement apparatus 13 sends the coins to the dispensing unit 120b.

In this manner, the coin settlement apparatus 13 can store a coin having been put into the depositing unit 110b, into the storing unit 150b, and can reversely send a coin stored in the storing unit 150b to the dispensing unit 120b. Namely, the coin settlement apparatus 13 is configured to reuse a coin having been deposited thereinto, as a coin to be dispensed.

When the money transport cassette 30 is attached to the cassette attaching unit 160b, the coin settlement apparatus 13 can load a coin from the money transport cassette 30 to the storing unit 150b, or collect a coin from the storing unit 150b to the money transport cassette 30. When a coin(s) is loaded, the money transport cassette 30 sends a coin(s) to the feeding unit 137b shown in FIG. 5A. At this time, the money transport cassette 30 may send the coins in a denomination mixed state to the feeding unit 137b. The feeding unit 137b feeds the coins to the transport unit 131b. The transport unit 131b transport the fed coins to the feeding unit 133b, and the feeding unit 134b feeds the coins, one by one, to the transport unit 130b. The transport unit 130b is configured to cause the fed coins to pass through the recognition unit 140b, and then to transport the coins to the storing unit 150b or the dispensing unit 120b. The recognition unit 140b recognizes a denomination of each of the coins being transported. The transport unit 130b store the coins by denomination to the storing unit 150b, based on the recognition result by the recognition unit 140b.

When a coin(s) is collected, the coin settlement apparatus 13 feed coins, one by one, from the storing unit 150b to the transport unit 131b. The transport unit 131b collects the fed coins to the money transport cassette 30.

In this manner, the coin settlement apparatus 13 is configured to load and collect a coin(s) by using the money transport cassette 30.

(Structure of Money Accounting Apparatus 21)

The money accounting apparatus 21 includes a coin accounting apparatus 23 and a banknote accounting apparatus 22. The coin accounting apparatus 23 is configured to dispense a coin to be loaded to the coin settlement apparatus 13, and to deposit a coin having been collected from the coin settlement apparatus 13. The banknote accounting apparatus 22 is configured to dispense a banknote to be loaded to the banknote settlement apparatus 12, and to deposit a banknote having been collected from the banknote settlement apparatus 12. A pair of the banknote accounting apparatus 22 and the coin accounting apparatus 23 constitute the money accounting apparatus 22.

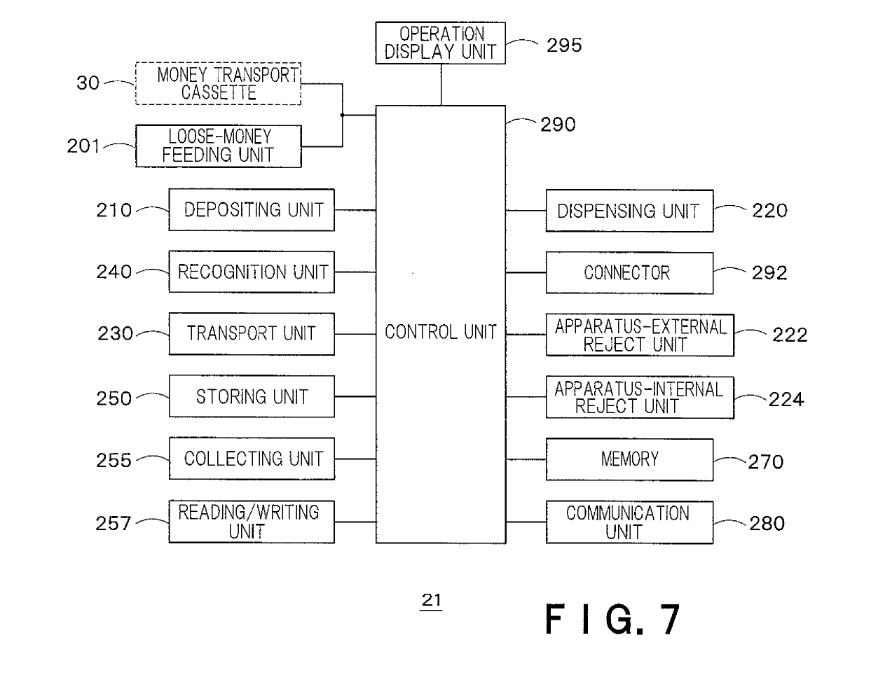

Herebelow, in order to differentiate constituent elements of the banknote accounting apparatus 22 and constituent elements of the coin accounting apparatus 23 from each other, a character “a” is added to a reference number of a constituent element of the banknote accounting apparatus 22, and a character “b” is added to a reference number of a constituent element of the coin accounting apparatus 23. Since the objects (a banknote and a coin) to be handled by the banknote accounting apparatus 22 and the coin accounting apparatus 23 differ from each other, the banknote accounting apparatus 22 and the coin accounting apparatus 23 differ from each other in concrete structures thereof. However, the basic block structure shown in FIG. 7 is common thereto. Note that, an operation display unit 295 is disposed any one of the banknote accounting apparatus 22 and the coin accounting apparatus 23, and is used in common to display information of both apparatuses.

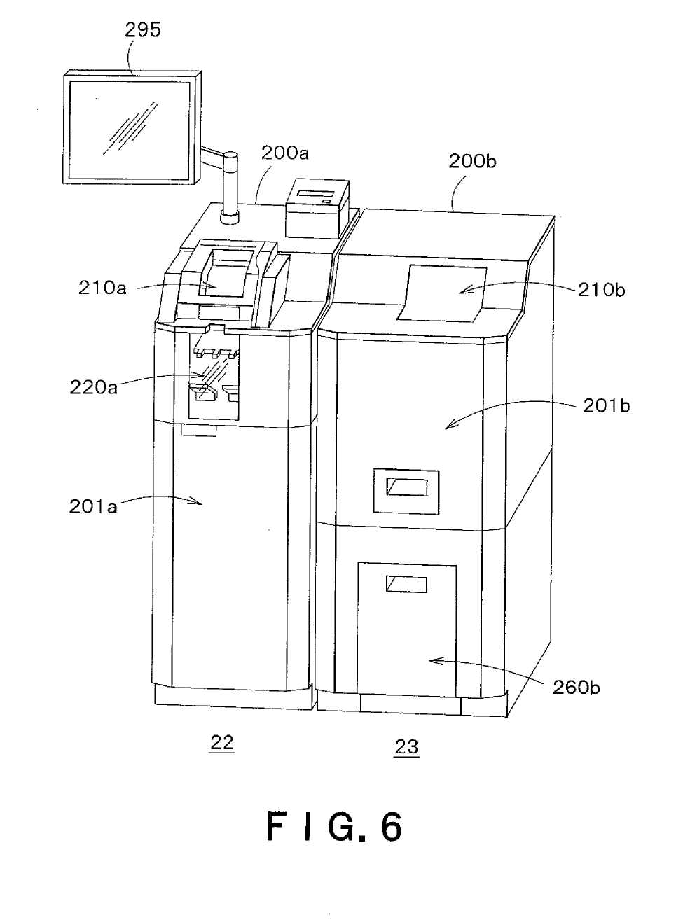

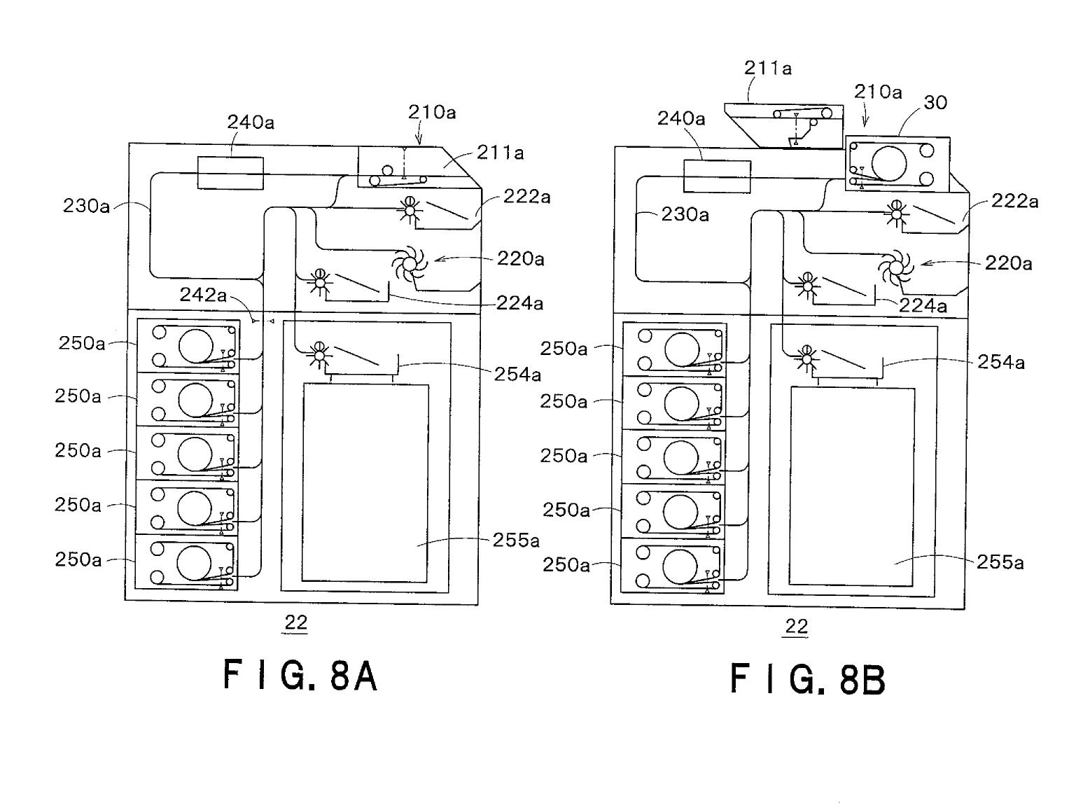

FIG. 6 is a view showing an appearance of an example of the money accounting apparatus 21. The money accounting apparatus 21 includes the banknote accounting apparatus 22 and the coin accounting apparatus 23. The banknote accounting apparatus 22 is composed of a housing 200a, a depositing unit 210a, a dispensing unit 220a and an operation display unit 295a. The depositing unit 210a is provided for depositing a banknote(s). The dispensing unit 220a is provided for dispensing a banknote(s). The deposing unit 210a is configured such that a loose-money feeding unit 211a for feeding loose banknotes and the money transport cassette 30 can be selectively attached thereto. Thus, the depositing unit 210a can deposit loose banknotes without using the money transport cassette 30, and can also deposit banknotes from the money transport cassette 30. The dispensing unit 220a can dispense loose banknotes without using the money transport cassette 30. When a front cover 201a is opened, there are disposed a collecting unit 255a and a storing unit 250a which are shown in FIG. 8.

The operation display unit 295 is configured to display conditions of the money accounting apparatus 21, the money settlement apparatus 11 and the money transport cassette 30. In addition, an operator can input data through the operation display unit 295. The operation display unit 295 may be a display of a touch panel type, for example.

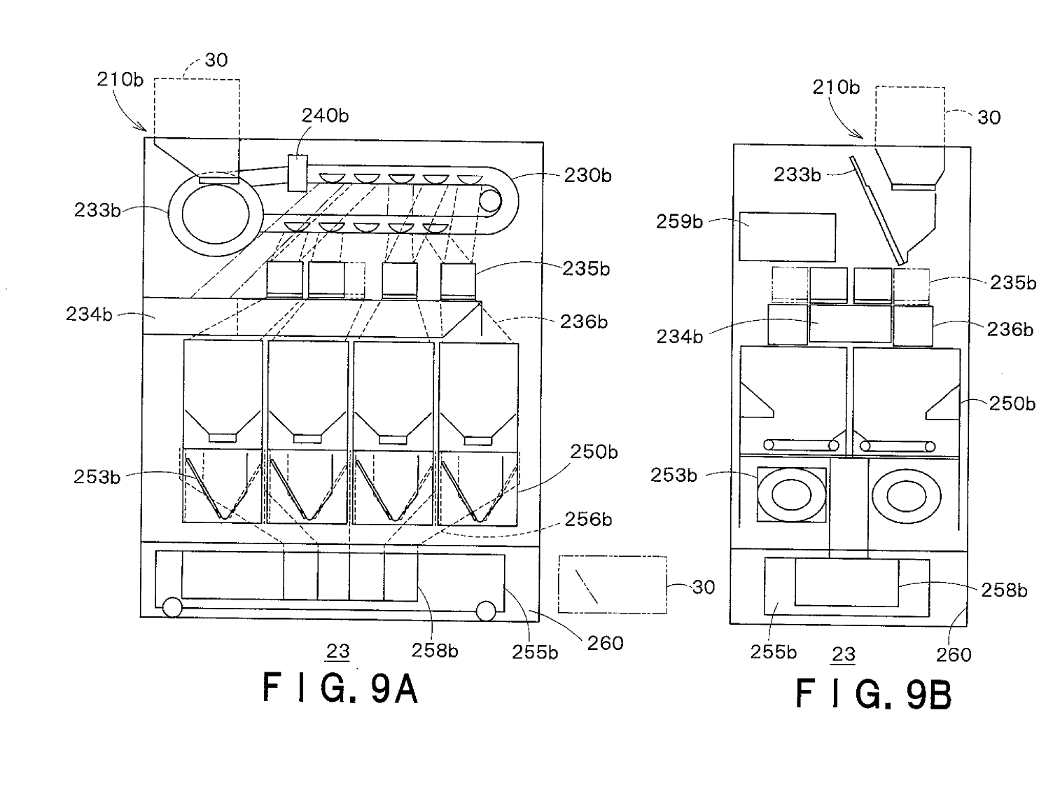

The coin accounting apparatus 23 is composed of a housing 200b, a depositing unit 210b and a drawer attaching unit 260 functioning as a dispensing unit 220b. The depositing unit 210b is provided for depositing a coin(s). The drawer attaching unit 260 is provided for dispensing a coin(s). The depositing unit 210b is configured such that loose coins can be put thereinto as they are, or the money transport cassette 30 can be attached thereto. Thus, the depositing unit 210b can deposit loose coins without using the money transport cassette 30, and can also deposit coins from the money transport cassette 30. The drawer attaching unit 260 is configured such that a storing drawer 258 storing coins by denomination and the money transport cassette 30 can be selectively attached thereto. Thus, the drawer attaching unit 260 can dispense coins without using the money transport cassette 30, and can also dispense coins to the money transport cassette 30. When a front cover 201b is opened, there is disposed a storing unit 250b shown in FIG. 9.

FIG. 7 is a block view showing a structural example of the money accounting apparatus 21. In addition to the depositing unit 210, the dispensing unit 220 and the operation display unit 295, the money accounting apparatus 21 further includes a transport unit 230, a recognition unit 240, a storing unit 250, a collecting unit 255, a reading/writing unit 257, an apparatus-external reject unit 222, an apparatus-internal reject unit 224, a memory 270, a communication unit 280, a connector 292 and a control unit 290.

The depositing unit 210 of the money accounting apparatus 21 is configured such that the loose-money feeding unit 201 and the money transport cassette 30 can be selectively attached thereto. For example, when a clerk deposit loose money to the money accounting apparatus 21, the loose-money feeding unit 201 is attached to the depositing unit 210. When a clerk deposits money to the money accounting apparatus 21 by using the money transport cassette 30, the money transport cassette 30, instead of the loose-money feeding unit 201, is attached to the depositing unit 210. Namely, the money accounting apparatus 21 is configured such that the money transport cassette 30, instead of the loose-money feeding unit 201, can be attached to and detached from the depositing unit 210.

The transport unit 230 transports money having been put into the depositing unit 210 to the storing unit 250, or transports money to be dispensed from the dispensing unit 220, from the storing unit 250. In addition, the transport unit 230 is configured to transport money from the storing unit 250 to the money transport cassette 30, or to transport money from the money transport cassette 30 to the storing unit 250.

The recognition unit 240 is configured to detect a denomination, an authenticity, a fitness, a version and an amount and so on of money being transported by the transport unit 230. For example, the recognition unit 240 has a sensor such as a magnetic sensor, a fluorescent sensor, a metal thread sensor, a thickness sensor or an image sensor. In addition, the recognition unit 240 counts an amount of money by denomination.

The storing unit 250 is configured to store, by denomination, money having been recognized by the recognition unit 240. When banknotes are stored, the storing unit 250 may be a storing unit of a stacking type or a storing unit of a tape reeling tape.

The reading/writing unit 257 is configured to read out information stored in the below-described memory unit 35 disposed on the money transport cassette 30, and to write information to the memory unit 35.

The connector 292 is configured to be connected to the money transport cassette 30, when the money transport cassette 30 is attached to the money settlement apparatus 11.

The memory 270 includes various programs for controlling the money accounting apparatus 21, a ROM or a HDD storing data, and a RAM serving as a program loading area or a working area when a program is executed, and so on. The memory 270 stores information of money (a denomination, an amount and so on) stored in the storing unit 250 and the money transport cassette 30. The memory 270 also stores the number of connection times showing how many times the money transport cassette 30 is connected to the connector 292. Further, the memory 270 may store, by denomination, an amount of money having been recognized by the recognition unit 240.

The communication unit 280 is communicably connected to other apparatuses (money accounting apparatus 21, money management apparatus 25, POS management apparatus 26) constituting the money handling system 1.

The control unit 290 is a processing unit configured to execute a program in the memory 270 to control the money accounting apparatus 21 as a whole. When the money transport cassette 30 is connected to the connector 292, the control unit 290 is configured to increase the number of connection times stored in the memory 270, and thereafter to rewrite the increased number of connection times to the memory 270. Further, the control unit 290 is configured to increase the number of connection times stored in the memory unit 35 of the money transport cassette 30, which has been read out by the reading/writing unit 257, and thereafter to rewrite the increased number of connection times to the memory unit 35 through the reading/writing unit 257.

Thus, a degree of wear of the connector 292 and the connector 39 of the money transport cassette 30 (see FIG. 10A and FIG. 11) can be detected, whereby the connectors 292 and 39 can be exchanged at suitable timings.

FIG. 8A and FIG. 8B are sectional vies showing an example of an inside structure of the banknote accounting apparatus 22 of the money accounting apparatus 21. FIG. 8A shows a condition in which a loose-banknote feeding unit 211a is attached to the depositing unit 210a, and FIG. 8B shows a condition in which the money transport cassette 30 is attached to the depositing unit 210a. Illustration of the operation display unit 295 is omitted in FIG. 8.

As shown in FIG. 8A, when a clerk deposits loose banknotes, the clerk attaches the loose-banknote feeding unit 211a to the depositing unit 210a. When the clerk puts a banknote(s) into the loose-banknote feeding unit 211a, the loose-banknote feeding unit 211a feeds the fed banknotes, one by one, to the transport unit 230a. The transport unit 230a is configured to cause the fed banknotes to pass through the recognition unit 240a, and then to transport the banknotes to the storing unit 250a, a collecting/stacking unit 254a or the apparatus-external reject unit 222a. The recognition unit 240a recognizes a denomination, an authenticity, a fitness, a version, an amount and so on of each of the banknotes being transported. The transport unit 230a stores the banknotes by denomination into the storing units 250a, based on the recognition result by the recognition unit 240a.

When the storing unit 250 is full and so on, the transport unit 230a may transport a banknote to the collecting and stacking unit 254a, according to need. When the number of banknotes stacked in the collecting and stacking unit 254 exceeds the predetermined number, a banknote is stored into the collecting unit 255a. In addition, when a banknote could not be recognized by the recognition unit 240 or a banknote was recognized as a counterfeit note, the transport unit 230a is configured to transport the banknote to the apparatus-external reject unit 222a.

On the other hand, when a banknote(s) is dispensed, the storing unit 250 is configured to feed banknotes, one by one, to the transport unit 230a. The transport unit 230a transports the fed banknotes to the dispensing unit 220a, and dispenses the banknotes. In the course of transporting the banknotes, when a sensor 242a detects an abnormal transport state such as an overlapped state, a chained state or a skewed state, the transport unit 230a transports the banknotes to the apparatus-internal reject unit 224a.

In this manner, the banknote accounting apparatus 22 can store a banknote having been put into the depositing unit 210a, into the storing unit 250a, and can reversely send a banknote stored in the storing unit 250a to the dispensing unit 220a. Namely, the banknote accounting apparatus 22 is configured to reuse a banknote having been put thereinto, as a banknote to be dispensed.

As shown in FIG. 8B, when the loose-banknote feeding unit 211a is rotated upward to be withdrawn and the money transport cassette 30, instead of the loose banknote feeding unit 201a, is attached to the depositing unit 210a, the banknote accounting apparatus 22 can deposit a banknote from the money transport cassette 30 to the storing unit 250a, or can dispense a banknote from the storing unit 250a to the money transport cassette 30.

When a banknote(s) is loaded to the money settlement apparatus 11, the storing unit 250a feeds banknotes, one by one, to the transport unit 230a, in order that the banknotes are transported to the money transport cassette 30. The transport unit 230a sends the fed banknotes to the money transport cassette 30. Thus, the banknote accounting apparatus 22 can send the banknotes, which are loaded to the money settlement apparatus 11, to the money transport cassette 30.

When a banknote(s) is collected from the money settlement apparatus 11, the money transport cassette 30 already includes banknotes having been collected from the money settlement apparatus 11. Thus, the money transport cassette 30 feed the banknotes therein, one by one, to the transport unit 230a, and the transport unit 230a stores the fed banknotes into the storing units 250a. In the course of transporting the banknotes, when the sensor 242a detects an abnormal transport state such as an overlapped state, a chained state or a skewed state, the transport unit 230a transports the banknotes to the apparatus-internal reject unit 224a.

In this manner, the banknote accounting apparatus 22 is configured to dispense a banknotes to be loaded to the money settlement apparatus 11, to the money transport cassette 30, and to deposit a banknote having been collected from the money settlement apparatus 11, from the money transport cassette 30.

FIG. 9A and FIG. 9B are sectional views showing an example of an inside structure of the coin accounting apparatus 23 of the money accounting apparatus 21. FIG. 9A is the sectional view of the coin accounting apparatus 23 when viewed from a lateral side, and FIG. 9B is the sectional view of the coin accounting apparatus 23 when viewed from a front side.

The coin accounting apparatus 23 has the depositing unit 210b, and is configured to deposit thereinto a coin having been collected from the money settlement apparatus 11, from the money transport cassette 30. The coin accounting apparatus 23 includes the collecting unit 255b and the drawer attaching unit 260 on which the money transport cassette 30 can be attached. When the money transport cassette 30 is attached to the drawer attaching unit 260, coins to be loaded to the money settlement apparatus 11 can be sorted by denomination and sent to the money transport cassette 30.

When loose coins are deposited, a clerk puts a coin(s) into the depositing unit 210b. At this time, the coins may be put thereinto in a denomination mixed state. The centrifugal disk-type feeding unit 233b is configured to feed, one by one, coins having been put into the depositing unit 210b, to the transport unit 230b. The transport unit 230b is configured to cause the fed coins to pass through the recognition unit 240b, and then to transport the coins to an escrow unit 235b. The escrow units 235b are disposed for respective denominations, and are configured to temporarily store a coin therein.

The recognition unit 240b recognizes a denomination, an authenticity, a fitness, a version, an amount and so on of each of the coins being transported. The transport unit 230b sorts the coins by denomination based on the recognition result by the recognition unit 240b, and sends a coin to the escrow unit 235b of a corresponding denomination.

The escrow units 235b communicate with the storing units 250b of corresponding denominations through chutes 236b. After all the coins having been put have been stored in the escrow units 235b, each coin is stored into the storing unit 250 of a corresponding denomination.

When the storing unit 250b is full and so on, the transport unit 230b may transport a coin to an overflow box 259b. When the escrow unit 235b is full, the transport unit 230b may transport a coin to the overflow box 259b. When a coin was recognized as a reject coin by the recognition unit 240b, the transport unit 230b may transport the reject coin to the reject unit 234b.

On the other hand, when loose coins are dispensed, the storing unit 250b is configured to feed coins, one by one, to the transport unit 231b. Each of the plurality of storing units 250b stores coins by denomination, and has the centrifugal disk-type feeding unit 253b. The feeding unit 253b feeds coins one by one, and transports the coins to a drawer 258b through a chute 256b. The drawer 258b serving as a coin dispensing unit is configured to store money by denomination. The shut 256b is configured to send money by denomination. Thus, the coin accounting apparatus 23 can send coins by denomination to the drawer 258b. Coins to be collected in the collecting unit 255b may be in a denomination mixed state.

In this manner, the coin accounting apparatus 23 can store a coin having been put into the depositing unit 210b, into the storing unit 250b, and can reversely send a coin stored in the storing unit 250b to the drawer 258b. Namely, the coin accounting apparatus 23 is configured to reuse a coin having been put thereinto, as a coin to be dispensed.

There is a case in which the POS register has a drawer into which money transferred upon the settlement process is manually stored. In this case, the storing drawer 258b is used when a coin is loaded to the drawer of the POS register in the checkout counter 10. A clerk loads a coin(s) having been dispensed to the storing drawer 258b of the coin accounting apparatus 21, to the drawer of the POS register. When a coin(s) is collected from the drawer of the POS register, a clerk puts a coin into the depositing unit 210b. The drawer of the POS register may be the same as the storing drawer 25 of the coin accounting apparatus 21, or may be different therefrom.

When the drawer of the POS register is the same as the storing drawer 258b of the coin accounting apparatus 21, the storing drawer 258b is attached to the coin accounting apparatus 21 upon loading process, and is attached to the POS register upon settlement process. In this case, it is not necessary for a clerk to transmit a coin from the storing drawer 258b of the coin accounting apparatus 21 to the drawer of the POS register. In addition, since the coin accounting apparatus 21 sorts coins by denomination and sends the coins to the storing drawer 258b, a clerk can perform a settlement process immediately after the storing drawer 258b has been attached to the coin accounting apparatus 21.

Meanwhile, when the drawer of the POS register is different from the storing drawer 258b of the coin accounting apparatus 21, the storing drawer 258b is attached to the coin accounting apparatus 21 upon loading process. A clerk transmits money having been sent to the storing drawer 258b, to the POS register upon settlement process. In this case, the structure of the storing drawer 258b of the coin accounting apparatus 21 may be different from the structure of the drawer of the POS register.

When the money transport cassette 30 is attached to the depositing unit 210b, the coin accounting apparatus 23 can deposit thereinto a coin having been collected from the money settlement apparatus 11, from the money transport cassette 30.

When a clerk attaches the money transport cassette 30 to the depositing unit 210b, the money transport cassette 30 puts a coin(s) into the feeding unit 233b. At this time, money may be put thereinto in a denomination mixed state. An operation succeeding thereto is the same as an operation when loose coins are deposited. Thus, coins are stored by denomination into the storing unit 250b.

When the money transport cassette 30, instead of the collecting unit 255b, is attached, the coin accounting apparatus 23 can send a coin(s) to be loaded to the money settlement apparatus 11, to the money transport cassette 30. In this case, similarly to the case where loose coins are dispensed, coins are sent to from the storing units 250b to the money transport cassette 30 through the chutes 256b. At this time, the coins having been sent to the money transport cassette 30 may be in a denomination mixed state.

In this manner, the coin accounting apparatus 23 can store a coin from the money transport cassette 30 into the storing unit 250b, and can reversely send a coin stored in the storing unit 250b to the money transport cassette 30.

FIGS. 10A and 10B are structural views showing an example of the position correcting unit 115 in this embodiment. The position correcting unit 115 includes a first and a second guides 1200a and 1200b, a first and a second racks 1210a and 1210b as transmission mechanisms, a first and a second springs (elastic members) 1220a and 1220b, a first and a second return springs 1230a and 1230b, a pinion 1240, a pinion rotating unit 1250, and a solenoid 1260 as a drive source.

Thus, the position correcting unit 115 corrects a position of a banknote or banknotes such that both side edges of the banknote(s), which is placed on a tray 112 as a banknote placement unit disposed on the depositing unit 110, conform to a direction in which the banknote is transported by the transport unit 130 (hereinafter referred to also as “feeding direction”) D2.

The first and the second guides 1200a and 1200b are operated in a width direction D1 of the banknote placed on the tray 112 to tap (jog, push) the both side edges of the banknote. In order that the opposed edge of the banknote come in parallel with the feeding direction D2, side surfaces of the guides 1200a and 1200b pushing the banknote is located substantially in parallel with the banknote feeding direction D2.

Herebelow, structures of the first guide 1200a, the first rack 1210a, the first spring 1220a and the first return spring 1230a are described below.

The first guide 1200a has a joint unit 1205a extending in the direction D1. The joint unit 1205a has an opening 1206a, and the first rack 1210a has an opening 1216a. A fastener 1215a joins the joint unit 1205a of the first banknote-pushing guide 1200a and the first rack 1210a through the openings 1206a and 1216a, so that the joint unit 1205a and the first rack 1200a are operable in the direction D1. Thus, the first guide 1200a can be relatively moved in the direction D1 with respect to the first rack 1210a.

In addition, the first spring (first elastic member) 1220a is provided between the joint unit 1205a of the first guide 1200a and the first rack 1210a. The first spring 1220a elastically pulls the first guide 1200a toward the second guide 1200b. This mechanism is a relief mechanism by which the first guide 1200a and the first rack 1210a are integrally operated. And, when a force not less than an elastic force (e.g., tensile force or compression force) of the first spring 1220a is applied in a direction where the first guide 1200a and the first rack 1210a are separated from each other, the first guide 1200a and the first rack 1210a are moved in directions separated apart from each other by the relief mechanism. Similarly, the second guide 1200b and the second rack 1210b have a relief mechanism by which the second guide 1200b and the second rack 1210b are integrally operated, and by which, when a force not less than a tensile force of the second spring (second elastic member) 1220b is applied in a direction where the second guide 1200b and the second rack 1210b are separated from each other, the second guide 1200b and the second rack 1210b are moved in directions separated apart from each other.

Thus, the first guide 1200a elastically pushes a side edge of a banknote. The second guide 1200b also elastically pushes a side edge of the banknote. Due to this structure, when a force not less than an elastic force of the first spring (elastic member) 1220a is applied between the first guide 1200a and a banknote, the first guide 1200a is not moved toward the banknote any more. In addition, when a force not less than an elastic force of the second spring (elastic member) 1220b is applied between the second guide 1200b and the banknote, the second guide 1200b is also not moved toward the banknote any more. As a result, the first spring 1220a and the second spring 1220b relieve drive forces transmitted from the first and the second racks 1210a and 1210b, when the first guide 1200a and the second guide 1200b, which are operated in cooperation with the first and the second racks 1210a and 1210b, push a banknote therebetween. Thus, the banknote is not deformed or flipped, when the first rack 1210a and the second rack 1210b push a banknote.

An elastic coefficient of the first spring 1220a is set based on a hardness or flexibility of a banknote. In this embodiment, springs are used as the first and the second elastic members 1220a and 1220b, but another elastic member (e.g., rubber) having a certain elastic coefficient may be used in place of a spring.

Further, the first rack 1210a is bonded to one end of the first return spring 1230a.

The other end of the first return spring 1230a is fixed to a given portion of a banknote change machine 11 which is stationary with respect to the solenoid 1260. The first return spring 1230a is provided for pulling the first guide 1200a together with the first rack 1210a to return to the original position (initial position), after the first guide 1200a has corrected a banknote.

The structures of the second guide 1200b, the second rack 1210b, the second spring 1200b, the second return spring 1230b, the joint unit 1205b, the openings 1206b and 1216b, and the fastener 1215b are mirror symmetric with the structures of the first guide 1200a, the first rack 1210a, the first spring 1200a, the first return spring 1230a, the joint unit 1205a, the openings 1206a and 1216a, and the fastener 1215a. Thus, since the former structures can be easily understood from the above description, description thereof is omitted.

The first rack 1210a and the second rack 1210b are joined to each other by the pinion 1240. Thus, the first rack 1210a and the second rack 1210b can be reciprocated in the direction D1 and the opposite directions, by the rotation of the pinion 1240.

A shaft of the pinion 1240 is connected to the pinion rotating unit 1250 composed of a plurality of links illustrated. The pinion rotating unit 1250 is connected to the solenoid 1260.

When the solenoid 1260 is turned on, the solenoid 1260 retracts a plunger 1261, and rotates the pinion 1240 through the pinion rotating unit 1250 in the right direction. Thus, the first and the second guides 1200a and 1200b are moved to come close to each other (see FIG. 10B). When the solenoid 1260 is turned off, the first and the second guides 1200a and 1200b, the pinion 1240, the pinion rotating unit 1250 and the plunger 1261 are returned to the original condition (FIG. 10A), by the action of the return springs 1230a and 1230b. In this embodiment, the solenoid 1260 is used as a drive source, but a motor such as a stepping motor may be used.

Due to such a structure, the first and the second guides 1200a and 1200b are reciprocated in the direction D1 (substantially perpendicular to the transport direction D2 of the transport unit 130) in a substantially horizontal plane with respect to a surface of a banknote placed on the tray 112, so as to tap the both side edges of the banknote in the direction D1. As a result, the direction and the position of the banknote are corrected, whereby width positions of a plurality of banknotes are conform to the transport direction D2. Alternatively, the width positions of the plurality of banknotes approximate the transport direction D2.

Referring to FIG. 10A, the first guide 1200a and the second guide 1200b are separated from each other, such that a user can easily put a banknote(s) to the tray 112. A distance between the first guide 1200a and the second guide 1200b at this time is indicated by W2. When the solenoid 1260 is not driven (initial state), the distance therebetween is W2. A width of the tray 112 is indicated by W1. A value of W1 may be the same as that of W2 or close thereto.

Referring to FIG. 10B, the first guide 1200a and the second guide 1200b come close to each other, such that the first and the second guide 1200a and 1200b are in contact with the both side edges of a banknote. A distance between the first guide 1200a and the second guide 1200b at this time is indicated by W3. When the solenoid 1260 is driven so that the first guide 1200a and the second guide 1200b are in contact with the both side edges of the banknote (operational state), the distance therebetween is W3.

The initial state shown in FIG. 10A and the operational state shown in FIG. 10B are performed once or plural times. In this manner, the both side edges of banknotes can be tapped by the first guide 1200a and the second guide 1200b.

FIG. 11 is a conceptual view showing an example of a banknote position correcting operation. For example, a 500-euro banknote, which is the largest in size among euro banknotes, is 82 mm in width and 160 mm in length. On the other hand, a 5-euro banknote, which is the smallest in size among euro banknotes, is 62 mm in width and 120 mm in length.

Thus, in the initial state, the distance W2 between the first guide 1200a and the second guide 1200b should be larger than 82 mm. In FIG. 11, the distance W2 is set as 86 mm which is obtained by adding 4 mm of margin to 82 mm. In this case, when a 5-euro banknote is inputted, a maximum skewed angle of the banknote is about 12.22 degrees. The skewed angle is an angle defined by a side edge of a banknote with respect to the feeding direction D2. Generally, when the skewed angle exceeds 6 degrees, it is difficult for the recognition unit 140 to recognize a banknote.

Thus, the position correcting unit 15 causes the first guide 1200a and the second guide 1200b to move respectively by 20 mm (40 mm) in the operational state. Thus, the distance W3 between the first guide 1200a and the second guide 1200b in the operational state is 66 mm. This value is obtained by adding 4 mm of margin to the width (62 mm) of the 5-euro banknote.

Thus, the skewed angle of the 5-euro banknote is corrected up to about 4.34 degrees. As a result, the recognition unit 140 can recognize the banknote. In addition, occurrence of banknote transport jam can be restrained.

Even when a banknote, which has a width larger than W3, such as a 500-euro banknote, is inputted, the first guide 1200a and the second guide 1200b elastically presses side edges of the banknote by the first spring 1220a and the second spring 1220b. Thus, the first spring 1220a and the second spring 1220b can relieve a drive force transmitted from the solenoid 1260, such that the banknote is not deformed or flipped. Thus, no problem occurs when the width of the inputted banknote is larger than W3. In addition, W3 may be smaller than the width of a 5-euro banknote.

FIG. 12 is a side view of the position correcting unit 115 when viewed from a lateral direction (either side in the direction D1).

In addition to the structure described with reference to FIG. 10A and FIG. 10B, the position correcting unit 115 further includes a banknote detection sensor 116 configured to detect a banknote having been put into the depositing unit 110, a banknote presser 320 configured to press a banknote upon banknote feeding operation, a feeding belt 1340 configured to feed a banknote to the transport unit 130, and a reverse roller 1330 configured to turn back an excessive banknote to separate banknotes one by one.

As shown in FIG. 11, the reverse roller 1330 and the feeding belt 1340 are located on substantially a center (middle) of a transport path.

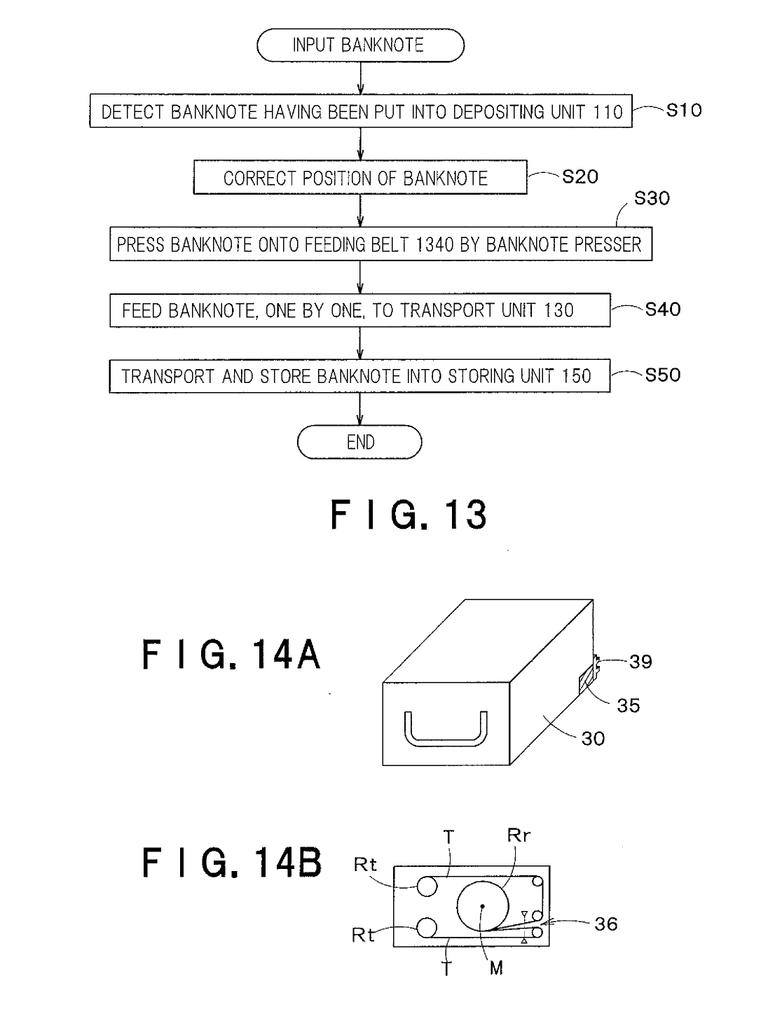

FIG. 13 is a flowchart showing a depositing operation of the banknote change machine 11 in this embodiment. At first, a user puts a banknote(s) into the depositing unit 110. The banknote detection sensor 116 of the depositing unit 110 detects the banknotes having been put into the depositing unit 110 (S10).

Upon detection of the banknotes by the banknote detection sensor 116, the position correcting unit 115 causes the first guide 1200a and the second guide 1200b to move such that the position of each banknote is corrected, by using the detection as a trigger (S20).

After the position of each banknote has been corrected by the position correcting unit 115, the banknote presser 1320 is lowered to press the banknotes onto the feeding belt 1340 (S30).

The reverse roller 1330 and the feeding belt 1340 are rotated, so that the banknotes are fed, one by one, to the transport unit 130 (S40).

Thereafter, the banknotes are transported by the transport unit 130, and stored by denomination into the storing units 150 based on a recognition result by the recognition unit 140 (S50).

According to this embodiment, the position correcting unit 115 corrects a direction of the banknote placed on the tray 112 by tapping the both side edges of the banknote in the direction D1, such that the extension directions of the both side edges of the banknote substantially conform to the feeding direction D2 or approximate the feeding direction D2. Thus, even when banknotes of various sizes are inputted in a skewed state or a biased state, the position and the skewed angle of each banknote can be corrected in the step S20, whereby the banknotes can be suitably fed.

The position correcting unit 115 can correct a position of a banknote such that a middle between both side edges of the banknote substantially conform to a middle between side edges of the tray 112, or approximate the middle between the side edges of the tray 112. Thus, in a banknote feeding operation, the reverse roller 1330 and the feeding belt 1340 can feed a banknote by pulling substantially a middle portion of the banknote.

Further, when a number of banknotes are placed on the tray 112, the first and the second guides 1200a and 1200b can align the banknotes such that both side edges of the banknotes substantially conform with each other, when viewed from above the surfaces of the number of banknotes.

As a result, a banknote jam during transportation can be restrained, and a banknote can be easily recognized.

### Alternative Example 1 of First Embodiment

The position correcting unit 115 may be disposed not only on the depositing unit 110 but also on the dispensing unit 120. When the position correcting unit 115 is disposed on the dispensing unit 120, a position of a dispensed banknote is corrected such that both side edges of the banknote conform to the transport direction of the transport unit 130.

Thus, when the banknote is dispensed, a user can easily take out the banknote from the dispensing unit.

### Alternative Example 2 of First Embodiment

In the above embodiment, both of the first and the second guides 1200a and 1200b have the relief mechanisms. However, the relief mechanism may be disposed only one of the first guide 1200a and the second guide 1200b. In this case, any one of the first elastic member 1220a and the second elastic member 1220b is omitted. For example, when the second elastic member 1220b is omitted, the second guide 1200b and the second rack 1210b are integrally operated. Also in this case, since the first guide 1200a is provided with the relief mechanism, when a banknote between the first guide 1200a and the second guide 1200b is pressed, the first guide 1200a can relieve a drive force transmitted from the first rack 1210a, such that the banknote is deformed or flipped.

### Alternative Example 3

Further, in the above embodiment, the first and the second guides 1200a and 1200b, which are placed on both sides of a banknote placed on the tray 112, are operated. However, the only one guide 1200a (1200b) may be movable. In this case, the other guide 1200b (1200a) is fixed. For example, when the first guide 1200a is movable and the second guide 1200b is fixed, the first guide 1200an elastically pushes one side edge of a banknote toward the second guide 1200b. Thus, the first guide 1200a can cause the both side edges of the banknote between the first guide 1200a and the second guide 1200b to be in almost parallel with the feeding direction D2.

### Second Embodiment

FIG. 14A and FIG. 14B are outline views of a structural example of the money transport cassette 30 of a tape reeling type, which is configured to transport a banknote(s). The money transport cassette 30 includes two tape reels Rt configured to feeding tapes, a winding reel Rr configured to reel up the tapes with a banknote(s) sandwiched therebetween, and a motor M configured to rotate the winding reel Rr. When the motor M rotates the winding reel Rr, the two tape reels Rt are rotated following to the rotation of the winding reel Rr.

When a banknote(s) is stored into the money transport cassette 30, the motor M rotates the winding reel Rr so that banknotes having been putted from an inlet/outlet 36 are sandwiched, one by one, between the two tapes, and the banknotes together with the tapes are reeled up around the winding reel Rr. When the banknotes are fed from the money transport cassette 30, the motor M reversely rotates the winding reel Rr so that the banknotes sandwiched between the two tapes are fed from the inlet/outlet 36, and the tapes are reeled up around the tape reels Rt. In this manner, the money transport cassette 30 can store a banknote or feed a banknote.

The motor M is driven by a power supplied from the money settlement apparatus 11 or the money accounting apparatus 21, when the money transport cassette 30 is attached to the money settlement apparatus 11 or the money accounting apparatus 21.

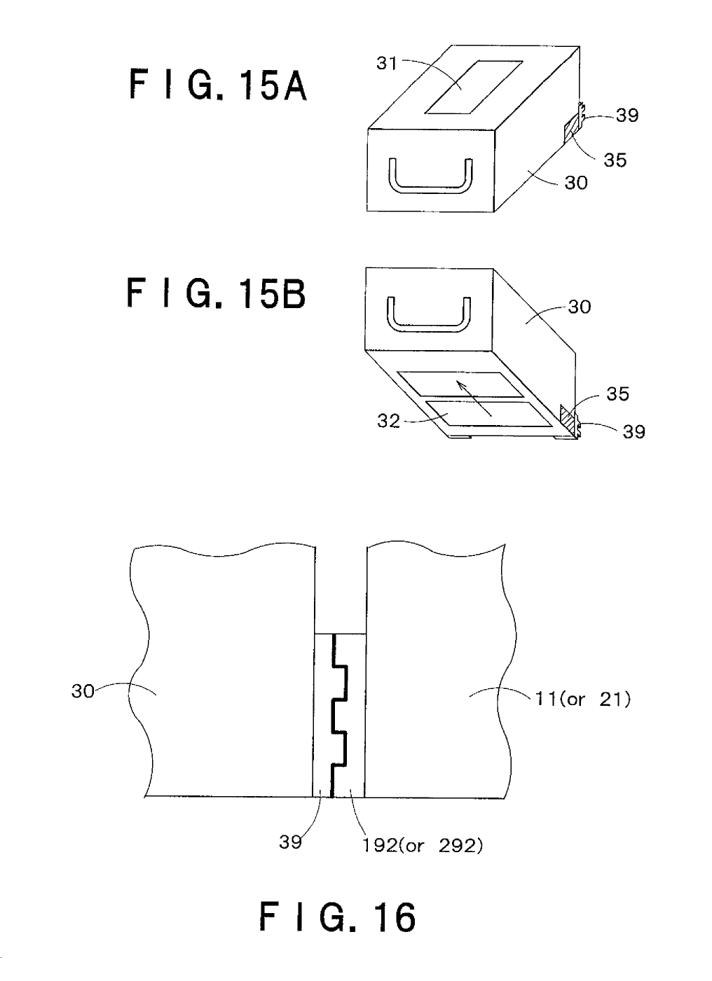

FIG. 15A and FIG. 15B are outline views showing a structural example of the money transport cassette 30 configured to transport a coin(s). The money transport cassette 30 configured to transport a coin(s) has an upper opening 31 and a lower opening 32.

For example, a case where a coin is collected from the coin settlement apparatus 13 shown in FIG. 5A is described. When the money transport cassette 30 is attached to the cassette attaching unit 160b, an actuator (not shown) disposed on the coin settlement apparatus 13 opens the upper opening 31 of the money transport cassette 30. At this time, the lower opening 32 remains closed. Thus, the coin settlement apparatus 13 can put a coin to be collected into the money transport cassette 30 through the upper opening 31.

A case where a coin is loaded to the coin settlement apparatus 13 is described. When the money transport cassette 30 is attached to the cassette attaching unit 160b, the actuator disposed on the coin settlement apparatus 13 opens the lower opening 32 of the money transport cassette 30. Thus, a coin in the money transport cassette 30 is sent to the feeding unit 137b through the lower opening 32.

When a coin to be loaded is put from the coin accounting apparatus 23 shown in FIG. 9A into the money transport cassette 30, the money transport cassette 30 is attached in place of the drawer 258b. At this time, an actuator disposed on the coin accounting apparatus 23 opens the upper opening 31 of the money transport cassette 30. The lower opening 32 remains closed. Thus, the coin accounting apparatus 23 can deposit the coin through the upper opening 31.

When a coin having been collected from the coin accounting apparatus 13 by using the money transport cassette 30 is collected to the coin accounting apparatus 23, the money transport cassette 30 is attached to the depositing unit 210b. At this time, an actuator disposed on the coin accounting apparatus 23 opens the lower opening 32 of the money transport cassette 30. The upper opening 31 remains closed. Thus, the coin in the money transport cassette 30 is sent to feeding unit 233b through the lower opening 32.

The money transport cassette 30 shown in FIG. 14A to FIG. 15B further includes the memory unit 35 and the connector 39. The memory unit 35 at least stores cassette ID information (cassette identification information) assigned to each money transport cassette 30 in order to specify the money transport cassette 30, and the number of connection times showing how many times the money settlement apparatus 11 or the money accounting apparatus 21 (herebelow, the money settlement apparatus 11 and the money accounting apparatus 21 are referred to as “money handling apparatus 11 or 21”) is connected to the connector 39. When the money transport cassette 30 is attached to the money handling apparatus 11 or 21, the connector 39 is couple to the connector 192 (or 292) of the money handling apparatus 11 or 21, so that the money transport cassette 30 and the money handling apparatus 11 or 21 are electrically connected to each other.

When the plurality of money transport cassettes 30 are present in the money handling system 1, the respective money transport cassettes 30 have cassette ID information different from each other. Thus, the money settlement apparatus 11 and the money accounting apparatus 21 can specify the plurality of money transport cassettes 30 and the numbers of connection times thereof. The cassette ID information may be a unique number set to each of the money transport cassettes 30. The memory unit 35 may store a denomination and an amount and so on of money stored in the money transport cassette 30 according to need.

It can be considered that the money settlement apparatus 11 is not connected for communication with the money accounting apparatus 21 and the money management apparatus 25. In this case, the memory unit 35 of the money transport cassette 30 may store, not only the cassette ID information of itself and the number of connection times thereof, but also denomination information and amount information of money to be loaded or collected, and ID information of the money settlement apparatus 11 to which the money is loaded or from which the money is collected. Thus, the money settlement apparatus 11 can recognize that the money settlement apparatus 11 itself is an object to be loaded, and can also recognize a denomination and an amount of the money to be loaded. In addition, the money accounting apparatus 21 can recognize from which one of money settlement apparatuses 11 the money in the money transport cassette 30 has been collected, and can also recognize a denomination and an amount of the collected money. Thus, even when the money settlement apparatus 11 is not connected for communication with the money accounting apparatus 21 and the money management apparatus 25, if the memory unit 35 of the money transport cassette 30 stores denomination information and amount information of money to be loaded or collected and ID information of the money settlement apparatus 11 to which the money is loaded or from which the money is collected, the money loading process and the money collecting process can be performed.

Each time when the money transport cassette 30 is connected to the money settlement apparatus 11 or the money accounting apparatus 21, the number of connection times stored in the memory unit 35 is read out by the reading/writing unit 157 or 257, increased in the control unit 190 or 290, and thereafter rewritten into the memory unit 35. Thus, a degree of wear of the connector 39 of the money transport cassette 30 can be managed, whereby the connector 39 can be exchanged at a suitable timing.

FIG. 16 is a view showing a structure of the connector 192 (or 292) as a first connector and a structure the connector 39 as a second connector.

The connector 192 (or 292) and the connector 39 may be a pair of connectors that are male-female coupled to each other. When the connector 192 (or 292) and the connector 39 are coupled to each other, the money transport cassette 30 is electrically connected to the money handling apparatus 11 or 21. Thus, the money handling apparatus 11 or 21 can drive the motor M of the money transport cassette 30 and can read out information from the memory unit 35.

The coupling manner between the connector 192 (or 292) and the connector 39 is not limited to the male-female coupling. Any coupling manner may be used as long as the coupled connector 192 (or 292) and the connector 39 provide electric connection.

(Operation of Money Handling System 1)

Next, a concrete operation of the money handling system 1 in this embodiment is described. A sum of money in each money settlement apparatus 11, a sum of money in the money accounting apparatus 21, a sum of money deposited into or dispensed from each money settlement apparatus 11 and a sum of money having been loaded or collected between the money accounting apparatus 21 and each money settlement apparatus 11 are managed by the money management apparatus 25. The plurality of money settlement apparatuses 11 respectively have unique ID information so as to be differentiated from each other, and each memory 170 of each of the money settlement apparatuses 11 stores its ID information. The money management apparatus 25 also recognizes the ID information of each money settlement apparatus 11. In the below processes, communication between each money settlement apparatus 11 and the money accounting apparatus 21 is performed via the money management apparatus 25. However, it is a matter of course that each money settlement apparatus 11 and the money accounting apparatus 21 can directly communicate with each other.

The money handling system 1 can be applied both to a banknote and to a coin. For example, when a banknote is handled, the banknote settlement apparatus 12 of the money settlement apparatus 11 may be used, and the banknote accounting apparatus 22 of the money accounting apparatus 21 may be used. In addition, a money transport cassette for banknote (either a stacking type or a tape reeling type will do) may be used as the money transport cassette 30.

On the other hand, when a coin is handled, the coin settlement apparatus 13 of the money settlement apparatus 11 may be used, and the coin settlement apparatus 23 of the money accounting apparatus 21 may be used. In addition, the money transport cassette for coin shown in FIG. 15A and FIG. 15B may be used as the money transport cassette 30.

Herebelow, although a banknote and a coin are expressed as “money” for the sake of convenience, the term “money” may be replaced with either “banknote” or “coin”.

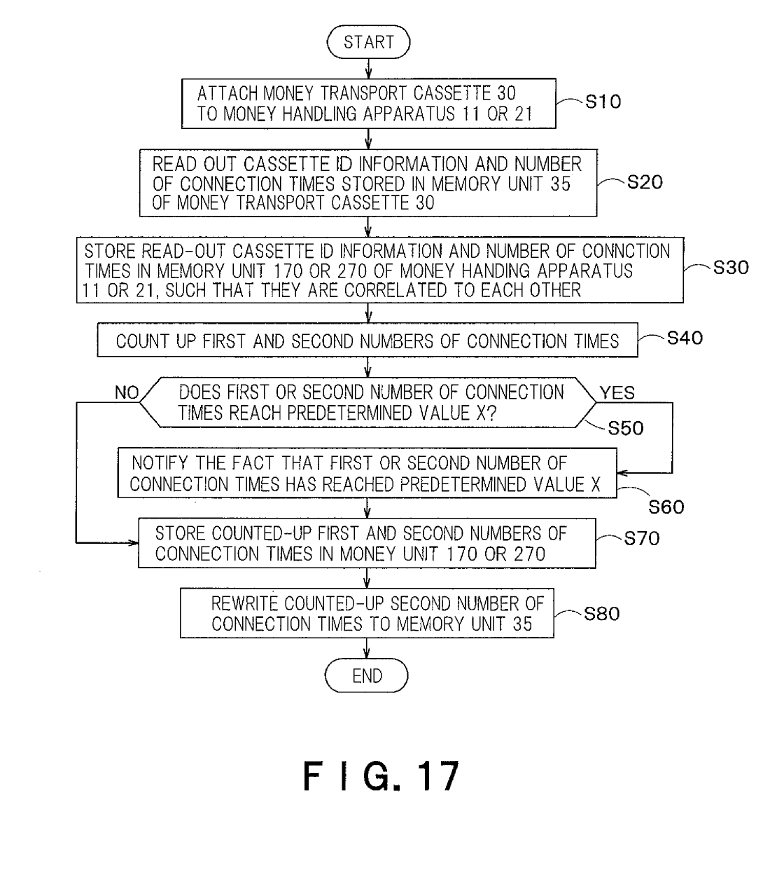

FIG. 17 is a flowchart showing an operation of the money handling system 1 in this embodiment. The money transport cassette 30 is attached to either the money settlement apparatus 11 or the money accounting apparatus 21. Thus, in the following description, “money handling apparatus 11 or 21” means either one of the money settlement apparatus 11 and the money accounting apparatus 21 on which the money transport cassette 30 is attached.

When money is loaded to the money handling apparatus 11 or 21, or when money in the money handling apparatus 11 or 21 is collected, an operator attaches the money transport cassette 30 to the money handling apparatus 11 or 21 (S10).

When the money handling apparatus 11 or 21 detects that the money transport cassette 30 has been attached thereto, namely, when the connector 39 of the money transport cassette 30 is electrically connected to the connector 192 or 292 of the money handling apparatus 11 or 21, the reading/writing unit 157 or 257 of the money handling apparatus 11 or 21 reads out the cassette ID information and the number of connection times stored in the memory unit 35 of the money transport cassette 30 (S20). The memory unit 170 or 270 of the money handling apparatus 11 or 21 stores the read-out cassette ID information and the number of connection times, such that the cassette ID information and the number of connection times are correlated to each other (S30).

Then, the control unit 190 or 290 counts up the number of connection times of the money handling apparatus 11 or 21 (referred to also as “first number of connection times” herebelow), which is stored in the memory 170 or 270 of the money handling apparatus 11 or 21, and also counts up the number of connection times of the money transport cassette 30 (referred to also as “second number of connection times” herebelow) (S40).

Then, the control unit 190 or 290 compares the first and the second numbers of connection times with a predetermined value X (S50). For example, the predetermined value X is an upper limit value of the number of connection times at which the electric connection between the connector 39 and the connector 192 or 292 can be guaranteed (guaranteed connection times) or a value lower than guaranteed connection times by a certain value. The predetermined value X has been stored beforehand in the memory unit 170 or 270 of the money handling apparatus 11 or 21. Alternatively, the money management apparatus 25, an accounting machine 100, the settlement apparatus, the POS register, etc. may store the predetermined value X beforehand. The predetermined value X is set as an upper limit value of the first or the second number of connection times in the control unit 190 or 290, or the money management apparatus 25, the accounting machine 100, the settlement apparatus, the POS register, etc. When the money management apparatus 25, the accounting machine 100, the settlement apparatus, the POS register, etc. set the predetermined value X, the money management apparatus 25, the accounting machine 100, the settlement apparatus, the POS register, etc. function as connection-times setting apparatuses.

When one of the first number of connection times and the second number of connection times reaches the predetermined value X (YES in S50), the money handling apparatus 11 or 21 notifies an operator that the first or the second number of connection times has reached the predetermined value X (S60). For example, the money handling apparatus 11 or 21 causes the operation display unit 195 or 295 as a notification unit to display that the first or the second number of connection times has reached the predetermined value X. Alternatively, the money handling apparatus 11 or 21 may be provided with a dedicated buzzer or a notification lamp which notifies that the first or the second number of connection times has reached the predetermined value X. Alternatively, the money management apparatus 25 may notify that the first or the second number of connection times has reached the predetermined value X.

When the first number of connection times reaches guaranteed connection times or when the first number of connection times comes close to guaranteed connection times, the connector 39 of the money transport cassette 30 is considered to be worn out. Thus, based on the notification that the first number of connection times has reached the predetermined value X, an operator can know a suitable exchange timing of the connector 39. In addition, when the second number of connection times reaches guaranteed connection times or when the second number of connection times comes close to guaranteed connection times, the connector 192 or 292 is considered to be worn out. Thus, based on the notification that the second number of connection times has reached the predetermined value X, an operator can know a suitable exchange timing of the connector 191 or 292.

The control unit 190 or 290 stores the first and the second numbers of connection times, which have been counted up, to the memory 170 or 270 (S70) Thus, the number of connection times of the connector 192 or 292 is updated. Further, the reading/writing unit 157 or 257 rewrites the second number of connection times, which is stored in the memory 170 or 270, to the memory unit 35 (S80). Thus, the number of connection times of the connector 39 is updated.

Neither the first number of connection times nor the second number of connection times reaches the predetermined value X (NO in S50), the control unit 190 or 290 stores the number of connection times of the money handling apparatus 11 or 21, which has been counted up, and the number of connection times of the money transport cassette 30, which has been counted up, to the memory 170 or 270 (S70). Thus, the number of connection times of the connector 192 or 292 is updated. Further, the reading/writing unit 157 or 257 rewrites the second number of connection times, which is stored in the memory 170 and 270, to the memory unit 35 (S80). Thus, the number connection times of the connector 39 is updated. At this time, it is not necessary for the money handling apparatus 11 or 21 to notify the first or the second number of connection times.

The flow of counting the number of connection times shown in FIG. 17 may be performed simultaneously with the money loading process or the money collecting process, or before or after one of these processes.

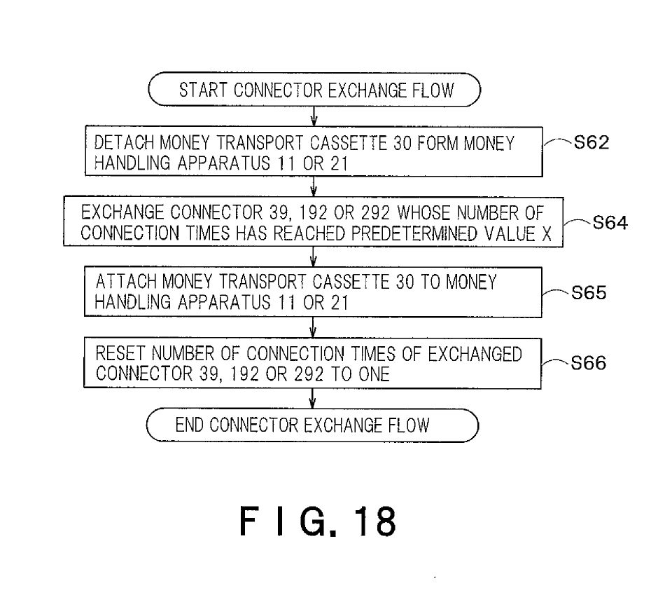

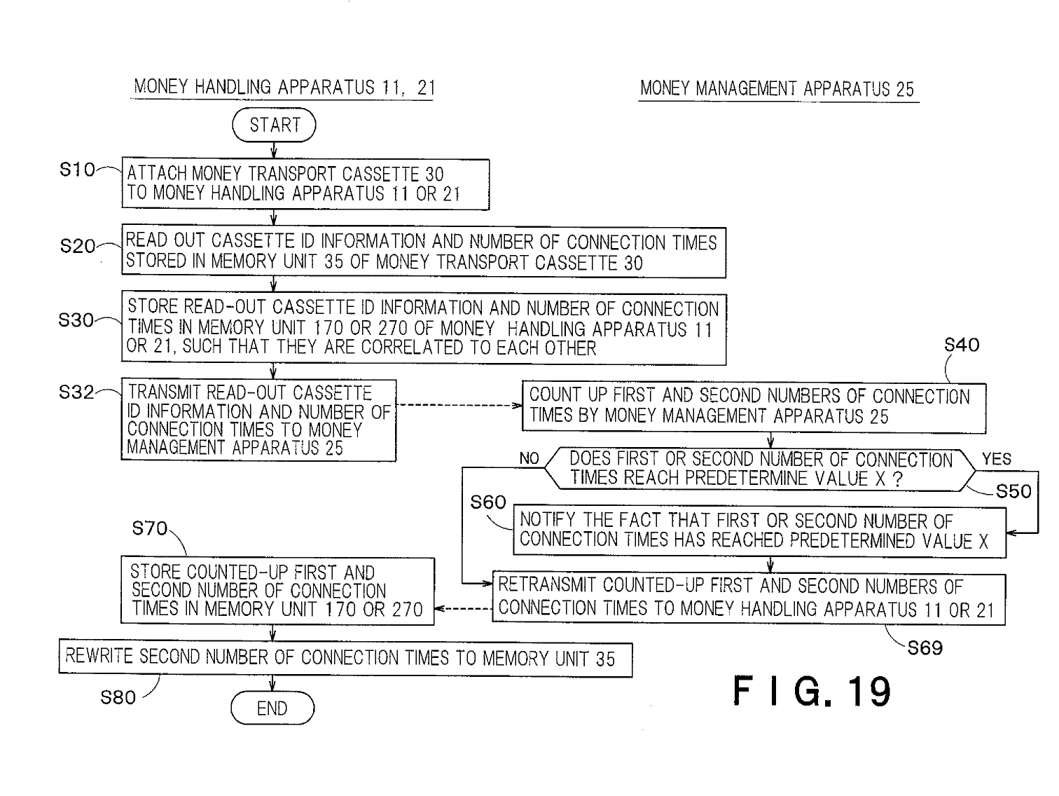

FIG. 18 is a flowchart showing an exchange operation of connectors in this embodiment. In this embodiment, even when one of the first number of connection times and the second number of connection times reaches the predetermined value X (YES in S50), the money loading process or the money collecting process is continuously performed. After the money loading process or the money collecting process has ended, an operator detaches the money transport cassette 30 from the money handling apparatus 11 or 21 (S62). Then, the operator exchanges the connector 39 or the connector 192 or 292 whose number of connection times has reached the predetermined value X (S64). Thereafter, when the money transport cassette 30 is attached to the money handling apparatus 11 or 21 (S65), an operator operates the operation display unit 195 or 295 of the money handling apparatus 11 or 21 or the money management apparatus 25 so as to reset the number of connection times of the exchanged connector 39 or the exchanged connector 192 or 292 to one (S66). Thereafter, the flow shown in FIG. 17 is repeatedly performed, and the money handling apparatus 11 or 21 can count the number of connection times of the exchanged new connector 39 or the exchanged new connector 192 or 292 from one.

In the step S65, the money transport cassette 30 may be attached to any one of the plurality of money handling apparatuses 11 and 21. This is because, since the money transport cassette 30 itself stores the number of connection times of itself in the memory unit 35 and the respective money handling apparatuses 11 and 21 store the predetermined value X in the memories 170 and 270, all the money handling apparatuses 11 and 21 can detect that the second number of connection times of the money transport cassette 30 has reached the predetermined value X.

The money handling system in this embodiment manages the number of connection times of the connector 192 or 292 of the money handling apparatus 11 or 21 and the number of connection times of the connector 39 of the money transport cassette 30. When one of the numbers of connection times has reached guaranteed connection times or when one of numbers of connection times comes close to guaranteed connection times, the money handling apparatus 11 or 21 or the money management apparatus 25 can notify an operator that the number of connection times has reached the predetermined value X.

Thus, an operator can know suitable exchange timings of the connector 39 and the connector 192 or 292. When the operator exchanges connectors in accordance with the notification, unsuccessful connection between the money transport cassette 30 and the money handling apparatus 11 or 21 can be prevented.

In addition, the plurality of money handling apparatuses 11 and 21 and the plurality of money transport cassettes 30 store the numbers of connection times of themselves. Thus, even when the numbers of connection times of the respective connectors widely vary, the money handling system 1 in this embodiment makes it possible that a connector is exchanged depending on the number of connection times of the connector. That is to say, in the money handling system 1 in this embodiment, it is not necessary to regularly exchange connectors and it is not necessary to set an exchange cycle at relatively a short term. In addition, in the money handling system 1 in this embodiment, it is possible not to exchange a connector that is not worn out with the small number of connection times, and it is possible to exchange a connector that is worn out with the large number of connection times. As a result, the money handling system 1 makes possible an efficient and economic application.

### Alternative Example of Second Embodiment

When one of the first number of connection times or the second number of connection times has reached the predetermined value X (YES in S50), the money handling apparatus 11 or 21 may make unavailable the money transport cassette 30, in addition to the notification that the first or the second number of connection times has reached the predetermined value X. In this case, the money handling apparatus 11 or 21 does not perform the money loading process or the money collecting process. Namely, in the alternative example 1, the money handling apparatus 11 or 21 performs the operation for counting the number of connection times shown in FIG. 17, but do not deposit and dispense money to and from the money transport cassette 30.

For example, the money handling apparatus 11 or 21 do not supply electric power to the motor M of the money transport cassette 30, which is shown in FIG. 14B, so as not to drive the winding reel Rr and the tape reels Rt. Alternatively, the money handling apparatus 11 or 21 does not open the upper opening 31 and the lower opening 32 of the money transport cassette 30, which are shown in FIG. 15A and FIG. 15B.

When the first number of connection times or the second number of connection times has reached the predetermined value X, the connector 39 of the money transport cassette 30 or the connector 192 or 292 of the money handling apparatus 11 or 21 is possibly worn out, so that there is a possibility that unsuccessful connecting between the money transport cassette 30 and the money handling apparatus 11 or 21 might occur.

In this case, a precise loading operation or a precise collecting operation may not be performed.

Thus, in the alternative example 1, when there is a possibility that unsuccessful contact between the money transport cassette 30 and the money handling machine 11 or 21 might occur, money transport between the money transport cassette 30 and the money handling apparatus 11 or 21 is inhibited beforehand. Thus, an error operation in the money transport cassette 30 and the money handling apparatus 11 or 21 can be prevented beforehand.

Even when the money loading operation or the money collecting operation is not performed, since the connector 39 and the connector 192 or 292 are connected to each other, the money handling apparatus 11 or 21 performs the operation for counting the number of connection times shown in FIG. 17. In addition, the connector exchange flow shown in FIG. 18 is performed. However, since the money loading operation or the money collecting operation is interrupted, in the step S65, the money transport cassette 30 should be again attached to the money handling apparatus 11 or 21 on which the money transport cassette 30 was attached in the step S10. Thus, the money handling apparatus 11 or 21 can resume the money loading operation or the money collecting operation.

### Alternative Example 2 of Second Embodiment

In this embodiment, the money management apparatus 25 may store and manage the first and the second numbers of connection times. In this case, in the step S50 in FIG. 17, when the first or the second number of connection times has reached the predetermined value X (YES in S50), the money handling apparatus 11 or 21 notifies an operator that the first or the second number of connection times has reached the predetermined value X (S60), and notifies the money management apparatus 25 that the first or the second number of connection times has reached the predetermined value X. The money management apparatus 25 may also notify an operator that the first or the second number of connection times has reached the predetermined value X.

Further, since the money management apparatus 25 manages all the first numbers of connection times and the all the second numbers of connection times, the steps S40 to S60 in the flow shown in FIG. 17 may be performed.

In this case, as shown in FIG. 19, after the step S30, the money handling apparatus 11 or 21 transmits the first number of connection times of itself, and the cassette ID information and the second number of connection times of the money transport cassette 30, which have been read out in the step S20, to the money management apparatus 25 (S32).

Then, after the steps S40 to S60 have been performed, the money management apparatus 25 retransmits the first and the second numbers of connection times, which have been counted up, to the money handling apparatus 11 or 21 (S69). The notification operation in the step S60 may be performed by the money handling apparatus 11 or 21 after the step S69. Thereafter, the steps S70 and S80 are performed. Thus, the number of connection times of the connector 39 and the number of connection times of the connector 192 or 292 are updated.

According to the alternative example 2, the money management apparatus 25 stores and manages the first and the second numbers of connection times. Thus, a processing load on the control unit 190 or 290 of the money handling apparatus 11 or 21 is small. Furthermore, the alternative examples 1 and 2 can provide the same effect as that of the first embodiment.

In the above second embodiment, connection between the money transport cassette 30 and the money handling apparatus 11 or 21 is detected by detecting electric connection between the connector 39 and the connector 192 or 292. However, the money transport cassette 30 and the money handling apparatus 11 or 21 may further include sensors such as optical sensors or magnetic sensors (not shown), and the connection therebetween may be detected by these sensors.

### Third Embodiment

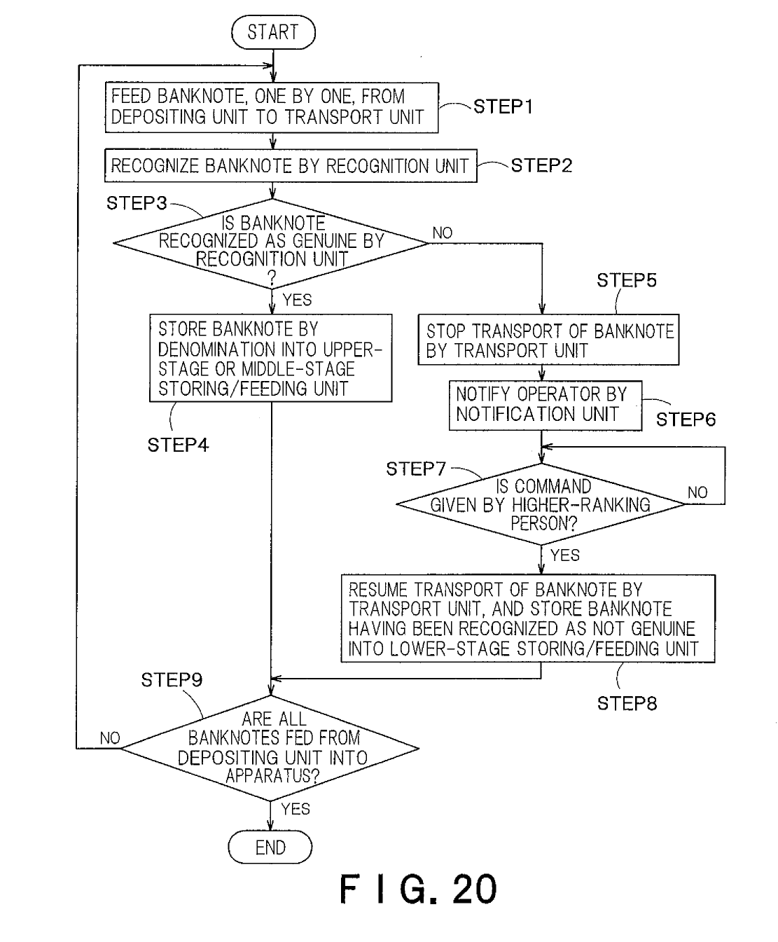

An operation of a banknote change machine 12 in a third embodiment is described with reference to the flowchart shown in FIG. 20. In the below-described operation of the banknote change machine 12, one storing/feeding unit 28 (e.g., the lower-stage storing/feeding unit 28) among the three storing/feeding units 28 is used to store a counterfeit note and a suspect note. Alternatively, a counterfeit note and a suspect note are not stored into the storing/feeding unit 28, but a counterfeit note and a suspect note may be stored into a storing/feeding unit (not shown) exclusively used for storing only a counterfeit note and the suspect note. The operation of the banknote change machine 12 described below is performed by the control unit 190 that controls the respective constituent elements of the banknote change machine 12.

When a banknote depositing operation is performed in the banknote change machine 12 in this embodiment, an operator firstly opens the depositing-unit cover 111a and puts a banknote(s) into the depositing unit 110a. When the operator gives a command for starting a depositing process to the control unit 190 through the operation unit 195, the banknotes are fed, one by one, from the depositing unit 110a to the transport unit 130a (STEP 1 of FIG. 20). The banknotes having been fed to the transport unit 130a are transported, one by one, by the transport unit 130a, and a denomination, an authenticity (genuine note or not), a fitness, a version and so on of each of the banknotes are recognized by the recognition unit 140a (STEP 2 of FIG. 20). When a banknote is recognized as genuine by the recognition unit 140a (“YES” in STEP 3 of FIG. 20), the banknote is transported by the transport unit 130a to the upper-stage or the middle-stage storing/feeding unit 28 so as to be stored in the storing/feeding unit 28, depending on the denomination of the banknote (STEP 4 of FIG. 20).

On the other hand, when a banknote is recognized as a counterfeit note or a suspect note and thus is recognized as not genuine by the recognition unit 140a (“NO” in STEP 3 of FIG. 20), the transport of banknotes by the transport unit 130a is stopped (STEP 5 of FIG. 20). In addition, at this time, the notification unit 52 notifies the operator by voice or display that a banknote that is not genuine has been recognized by the recognition unit 140a (STEP 6 of FIG. 20). The recognized information of the banknote recognized by the recognition unit 140a, specifically, a denomination, an image, a serial number and the like, may be notified by the notification unit 52. Further, a banknote stop location in the housing 100a of the banknote change machine 12 may be notified by the notification unit 52. Thereafter, when an operator or a person having an authority confirms the notified contents having been notified by the notification unit 52 and judges that the banknote should be stored into the storing/feeding unit 28, a higher-ranking person gives a storing command to the control unit 190 through the operation unit 195 (“YES” in STEP 7 of FIG. 20). Then, the transport of the banknotes by the transport unit 130a is resumed, and the banknote having been recognized as not genuine by the recognition unit 140a is transported to the lower-stage storing/feeding unit 28 so as to be stored in the storing/feeding unit 28 (STEP 8 of FIG. 20). When the banknotes is stored into the storing/feeding unit 28, the memory unit 170 stores a storing order of the banknote stored in the storing/feeding unit 28, together with other information such as the denomination, the serial number and so on of the banknote. Thus, the counterfeit note or the suspect note can be confirmed thereafter. In addition, when the operator or the person confirming the notified contents by the notification unit 52 judges that the banknote cannot be stored into the banknote change machine 12, a higher-ranking person removes the banknote, or collects the banknote by inputting a collecting command to the control unit 190 through the operation unit 195. The collected banknote is separately managed in the back office.

Although not shown in the flowchart, when a banknote has been recognized as genuine by the recognition unit 140a but the storing/feeding unit 28 corresponding to a denomination of the banknote (upper-stage or middle-stage storing/feeding unit 28) is full, the banknote is transported to a collecting cassette 30 so as to be stored in the collecting cassette 30.

The aforementioned operation shown in the STEP 1 to STEP 8 of FIG. 20 is performed until all the banknotes are fed from the depositing unit 110a into the housing 100a (“NO” in STEP 9 of FIG. 20). When all the banknotes have been fed from the depositing unit 110a into the housing 100a so that there is no banknote in the depositing unit 110a (“YES” in STEP 9 of FIG. 20), the depositing operation is ended. The depositing operation may not be ended immediately after all the banknotes have been fed from the depositing unit 110a into the housing 100a, but the notification unit 52 may notify an operator that all the banknotes have been fed from the depositing unit 110a into the housing 100a. In this case, after the operator gives a confirmation command to the control unit 190 through the operation unit 195, the depositing process is ended.

According to the first aspect of the operation of the banknote change machine 12, when a banknote has been recognized as not genuine by the recognition unit 140a, the control unit 190 controls the transport unit 130a such that the banknote is not returned to the outside of the housing 100a. Specifically, when a banknote has been recognized as not genuine by the recognition unit 140a, the control unit 190 controls the transport unit 130a such that the transport of banknotes by the transport unit 130a is stopped.

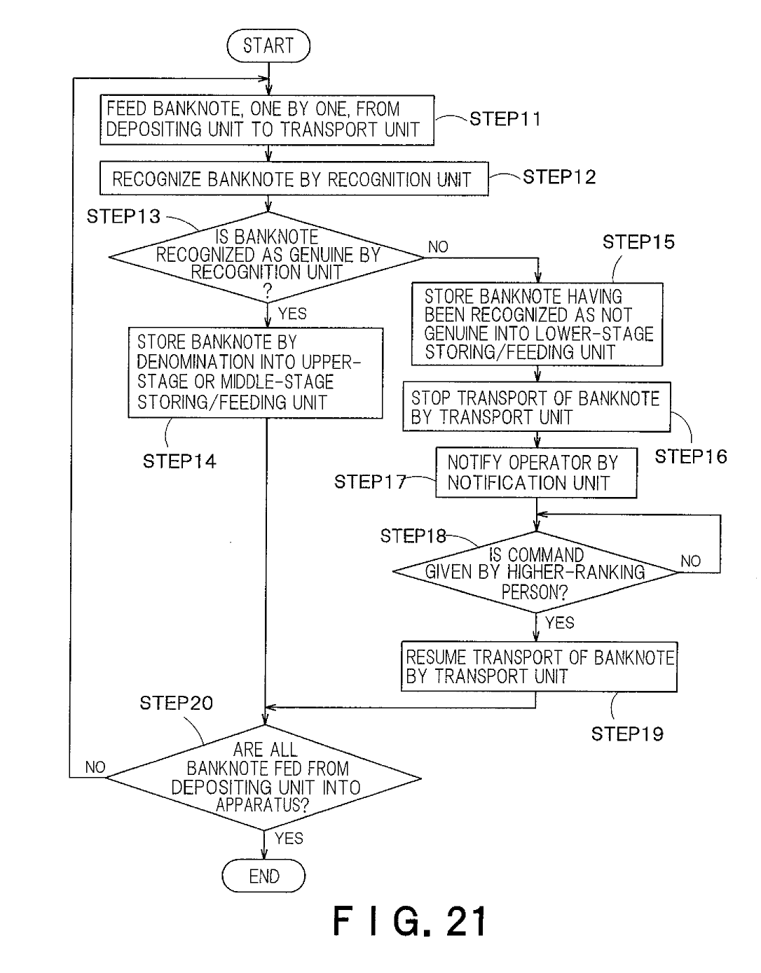

Next, a second aspect of the operation of the banknote change machine 12 is described with reference to the flowchart shown in FIG. 21. Also in the second aspect of the operation of the banknote change machine 12 described herebelow, one storing/feeding unit 28 (e.g., the lower-stage storing/feeding unit 28) among the three storing/feeding units 28 is used for storing a counterfeit note and a suspect note. The operation of the banknote change machine 12 described below is performed by the control unit 190 that controls the respective constituent elements of the banknote change machine 12.

Similarly to the first aspect of the operation of the banknote change machine 12, an operator firstly opens the depositing-unit cover 111a and puts a banknote(s) into the depositing unit 110a. When the operator gives a command for staring a depositing process to the control unit 190 through the operation unit 195, the banknotes are fed, one by one, from the depositing unit 110a to the transport unit 130a (STEP 11 of FIG. 21). The banknotes having been fed to the transport unit 130a are transported, one by one, by the transport unit 130a, and a denomination, an authenticity (genuine note or note), a fitness, a version and so on of each of the banknotes are recognized by the recognition unit 140a (STEP 12 of FIG. 21). When a banknote is recognized as genuine by the recognition unit 140a (“YES” in STEP 13 of FIG. 21), the banknote is transported by the transport unit 130a to the upper-stage or the middle-stage storing/feeding unit 28 so as to be stored in the storing/feeding unit, depending on the denomination of the banknote (STEP 14 of FIG. 21).

On the other hand, when a banknote is recognized as a counterfeit note or a suspect note and thus is recognized as not genuine by the recognition unit 140a (“NO” in STEP 13 of FIG. 21), the banknote is transported by the transport unit 130a to the lower-stage storing/feeding unit 28 so as to be stored in the storing/feeding unit 28 (STEP 15 of FIG. 21). When the banknote having been recognized as not genuine is stored into the lower-stage storing/feeding unit 28, the transport of banknotes by the transport unit 130a is stopped (STEP 16 of FIG. 21). At this time, the notification unit 52 notifies the operator by voice or display that a banknote that is not genuine has been recognized by the recognition unit 140a (STEP 17 of FIG. 21). At this time, the recognized information of the banknote recognized by the recognition unit 140a, specifically, a denomination, an image, a serial number and the like, may be notified by the notification unit 52. Thereafter, when an operator or a person having an authority confirms the notified contents having been notified by the notification unit 52 and judges that the banknote should be stored into the storing/feeding unit 28, a higher-ranking person gives a storing command to the control unit 190 through the operation unit 195 (“YES” in STEP 18 of FIG. 21). Then, the transport of the banknotes by the transport unit 130a is resumed (STEP 19 of FIG. 21). When the banknotes is stored into the storing/feeding unit 28, the memory unit 170 stores a storing order of the banknote stored in the storing/feeding unit 28, together with other information such as the denomination, the serial number and so on of the banknote. Thus, the counterfeit note or the suspect note can be confirmed thereafter. In addition, when the operator or the person confirming the notified contents by the notification unit 52 judges that the banknote cannot be stored into the banknote change machine 12, a higher-ranking person removes the banknote, or collects the banknote by inputting a collecting command to the control unit 190 through the operation unit 195. The collected banknote is separately managed in the back office.

The aforementioned operation shown in STEP 11 to STEP 19 of FIG. 21 is performed until all the banknotes are fed from the depositing unit 110a into the housing 100a (“NO” in STEP 20 in FIG. 21). When all the banknotes have been fed from the depositing unit 110a into the housing 100a so that there is no banknote in the depositing unit 110a (“YES” in STEP 20 of FIG. 21), the depositing operation is ended. The depositing operation may not be ended immediately after all the banknotes have been fed from the depositing unit 110a into the housing 100a, but the notification unit 52 may notify the operator that all the banknotes have been fed from the depositing unit 110a into the housing 100a. In this case, after the operator gives a confirmation command to the control unit 190 through the operation unit 195, the depositing process is ended.

According to the second aspect of the operation of the banknote change machine 12, when a banknote has been recognized as not genuine by the recognition unit 140a, the control unit 190 controls the transport unit 130a such that the banknote is not returned to the outside of the housing 100a. Specifically, when a banknote has been recognized as not genuine by the recognition unit 140a, the control unit 190 controls the transport unit 130a such that the banknote is transported to the lower-stage storing/feeding unit 28 so as to be stored in the storing/feeding unit 28, and then the transport of banknotes by the transport unit 130a is stopped.

In the banknote change machine 12 in this embodiment, the operation of the banknote change machine 12 is not limited to the above-described first and the second aspects. Another operation of the banknote change machine 12 is described below.

In the banknote change machine 12, a banknote stop location is provided on a position that is inaccessible from the outside of the housing 100a. The banknote stop location may be a certain position in the transport path of the transport unit 130a or the dispensing unit 120a whose outlet is closed by the dispensing-unit shutter 121a. Another banknote stop location may be the storing/feeding unit 28 or a transport unit in the transport path. A banknote, which has been recognized as not genuine by the recognition unit 140a, is stopped at the banknote stop location. To be more specific, when banknotes are fed, one by one, from the depositing unit 110a to the transport unit 130a, and recognized by the recognition unit 140, if a banknote is recognized as not genuine by the recognition unit 140, the banknote is transported by the transport unit 130a to the dispensing unit 120a whose outlet is closed by the dispensing-unit shutter 121a, or to a certain position in the transport path of the transport unit 130a. Thereafter, the transport of banknotes by the transport unit 130a is stopped. At this time, the notification unit 52 notifies an operator that a banknote that is not genuine has been recognized by the recognition unit 140a. In addition to the recognized information of the banknote recognized by the recognition unit 140a, or in place of the recognized information, a banknote stop location in the housing 100a may be notified by the notification unit 52. Thereafter, when an operator gives a confirmation command to the control unit 190 through the operation unit 195, the transport of the banknotes by the transport unit 130a is resumed.

Alternatively, a storing unit (not shown) for storing a counterfeit note and a suspect note may be disposed inside the banknote change machine 12. In this case, the aforementioned storing unit may be used as the banknote stop location.

When the plurality of banknote stop locations are provided, as shown in FIG. 3, the control unit 190 may include a stop-location selecting unit 62. When a banknote has been recognized as not genuine by the recognition unit 140a, the stop-location selecting unit 62 disposed on the control unit 190 is configured to select one of the plurality of banknote stop locations at which the banknote is stopped. More specifically, when an operator gives a command to the control unit 190 through the operation unit 195, the stop-location selecting unit 62 selects one of the banknote stop locations, and the banknote having been recognized as not genuine is transported to the selected banknote stop location.

As described above, according to the banknote change machine 12 and the banknote handling method in this embodiment, when a banknote has been recognized as not genuine by the recognition unit 140a, the control unit 190 is configured to control the transport unit 130a such that the banknote is not returned to the outside of the housing 100a. Thus, even when a regulation similar to the regulation of the European financial markets is applied to retail markets, since a counterfeit note and a suspect note will not be returned to the outside of the housing 100a, the aforementioned regulation can be obliged.

The banknote handling apparatus and the banknote handling method of the present invention are not limited to the above embodiments, and can be variously modified. For example, as shown in the STEP 6 of FIG. 20 and the STEP 17 of FIG. 21, when the notification unit 52 notifies an operator that a banknote that is not genuine has been recognized by the recognition unit 140a, the operator or a person having an authority may give a returning command to the control unit 190, instead of giving the storing command, through the operation unit 195. When the operator gives the returning command to the control unit 190 through the operation unit 195, the banknote having been recognized as not genuine is returned to the depositing unit 110a so as to be returned to the operator. In this manner, when the notification unit 52 notifies that a banknote that is not genuine has been recognized by the recognition unit 140a, the operator may input a command as to whether the banknote should be taken into the housing 100a or not, to the control unit 190 through the operation unit 195.

In addition, when the banknote having been recognized as not genuine by the recognition unit 140a is returned to the depositing unit 110a, only a part of the banknote may be exposed to the outside from the depositing unit 110a. In this case, the remaining part of the banknote is still taken in the housing 100a, so that an operator cannot take the banknote to the outside. Thereafter, when an operator or a person having an authority confirms the notified contents having been notified by the notification unit 52 and judges that the banknote should be stored into the storing/feeding unit 28, a higher-ranking person gives a storing command to the control unit 190 through the operation unit 195, so that the banknote is stored into the storing/feeding unit 28. When the banknotes is stored into the storing/feeding unit 28, the memory unit 170 stores a storing order of the banknote stored in the storing/feeding unit 28, together with other information such as the denomination, the serial number and so on of the banknote. Thus, the counterfeit note or the suspect note can be confirmed thereafter. In addition, when the operator or the person confirming the notified contents by the notification unit 52 judges that the banknote cannot be stored into the banknote change machine 12, a higher-ranking person removes the banknote, or collects the banknote by inputting a collecting command to the control unit 190 through the operation unit 195. The collected banknote is separately managed in the back office.

In addition, in the banknote handling apparatus 12 shown in FIG. 2 and FIG. 4, the inlet in the depositing unit 110a and the outlet in the dispensing unit 120a are provided separately from each other. However, the inlet and the outlet may be integrated with each other. Namely, the inlet in the depositing unit 10a may function as the outlet through which a banknote is dispensed from the inside of the housing 100a to the outside thereof. In this case, a reject banknote that is rejected because of an abnormal transport state such as a skewed state and an overlapped state may be returned to the inlet in the depositing unit 110a. When the inlet and the outlet are integrated with each other, after a process of a first banknote has been established, a succeeding banknote in the depositing unit 110a can be taken into the housing 100a.

In addition, as shown in FIG. 2 and FIG. 4, in a case where the inlet in the depositing unit 110a and the outlet in the dispensing unit 120a are provided separately from each other, a reject banknote that is rejected because of an abnormal transport state such as a skewed state and an overlapped state may be returned to the outlet in the dispensing unit 120a.

In addition, when a banknote is recognized as a counterfeit note or a suspect note and thus is recognized as not genuine by the recognition unit 140a, the notification unit 52 may not notify an operator that a banknote that is not genuine has been recognized by the recognition unit 140a, but a signal relating to the information may be transmitted to the higher-ranking apparatus 21 such as the POS system via the interface 180. In this case, the higher ranking machine notifies that a banknote that is not genuine has been recognized by the recognition unit 140a. In addition, at this time, a signal relating to the recognized information (for example, a signal relating to information such as a denomination, an image, a serial number and so on) recognized by the recognition unit 140a and a signal relating to information of a banknote stop position in the housing 100a may be transmitted from the control unit 190 to the higher-ranking apparatus 21 such as a POS system via the interface 180. In addition, a display unit such as a customer display may be connected to the outside of the banknote change machine 12, and this display unit may display information showing that a banknote that is not genuine has been recognized by the recognition unit 140a, and recognized information of the banknote recognized by the recognition unit 140a.

When a counterfeit note or a suspect note, which has been detected by the recognition unit 140a, is caused to be stored into the lower-stage storing/feeding unit 28 but the lower-stage storing/feeding unit 28 is full, the counterfeit note or the suspect note may be stored into the upper-stage or the middle-stage storing/feeding unit 28. In this case, since the information relating to banknotes stored in the respective storing/feeding units 28 is stored in the memory unit 170, it can be understood which storing/feeding unit 28 stores the counterfeit note or the suspect note and the order thereof. Thus, in a banknote dispensing operation, the counterfeit note or the suspect note can be transported to another storing/feeding unit 28, instead of being transported to the outlet in the dispensing unit 120a. In addition, in a banknote collecting operation, since it can be understood that which storing/feeding unit 28 stores the counterfeit note or the suspect note and the order thereof, the counterfeit note or the suspect note can be found after collection.

In addition, in a case where the banknote handling apparatus according to this embodiment is used as the banknote change machine 12 shown in FIG. 2 and so on, the banknote change machine 12 functions as a manned change machine when connected to a POS register, or the banknote change machine 12 functions as an unmanned change machine when connected to a self-checkout register. In addition, the banknote handling machine in this embodiment may be connected to the cash management apparatus installed in the back office. In this case, the banknote handling machine according to this embodiment functions as a back office machine.

The aforementioned first to third embodiments can be carried out when two of them are combined with each other. Moreover, the first to third embodiments can be carried out when all of them are combined with each other.

1. A money handling machine comprising:
a depositing unit configured to put a banknote thereinto;
a storing unit configured to store the banknote;
a transport unit configured to transport the banknote from the depositing unit to the storing unit; and
a position correcting unit configured to correct a position of the banknote having been put into the depositing unit, such that a direction of both side edges of the banknote approximates a transport direction of the transport unit, the side edges of the banknote longitudinally expanding with respect to a transport direction.

2. The money handling machine according to claim 1 further comprising a banknote placement unit configured to place thereon the banknote having been put into the depositing unit,
wherein the position correcting unit is configured to correct the position of the banknote having been put into the depositing unit, such that a middle of the both side edges of the banknote approximates a middle of the banknote placement unit.

3. The money handling machine according to claim 1 wherein:
the position correcting unit is configured to align a plurality of banknotes having been put into the depositing unit, such that the both side edges of the banknotes substantially conform to each other, when the banknotes having been put into the depositing unit are viewed from above surfaces thereof.

4. The money handling apparatus according to claim 1, wherein
the position correcting unit includes:
at least one guide being movable substantially perpendicular to the transport direction of the transport unit, in a horizontal plane with respect to a surface of the banknote having been put into the depositing unit;
a drive source configured to move the guide such that the guide elastically pushes the side edge of the banknote; and
a transmission mechanism configured to transmit a drive force of the drive source to the guide through an elastic member.

5. The money handling apparatus according to claim 1, wherein
the depositing unit includes a sensor configured to detect the banknote having been put thereinto or dispensed; and
the position correcting unit is configured, when the sensor detects the banknote, to correct a position of the banknote.

6. The money handling apparatus according to claim 1 further comprising a dispensing unit configured to dispense the banknote,
wherein:
the transport unit is configured to transport the banknote from the storing unit to the dispensing unit; and
the dispensing unit includes a position correcting unit configured to correct a position of the banknote having been dispensed to the dispensing unit, such that a direction of both side edges of the banknote approximates the transport direction of the transport unit, the side edges of the banknote longitudinally expanding with respect to a transport direction.

7. A money handling system comprising a money handling apparatus configured to deposit or dispense money, and a money transport cassette attachable to and detachable from the money handling apparatus in order to transport money so as to deposit the money to the money handling apparatus or to dispense the money from the money handling apparatus,
wherein the money handling apparatus includes:
a first connection unit to be connected to the money transport cassette, when the money transport cassette is attached to the money handling apparatus;
a first memory unit configured to store a first number of connection times showing how many times the money transport cassette has been connected to the first connection unit; and
a control unit configured to increase the first number of connection times, when the money transport cassette is connected to the first connection unit.

8. The money handling system according to claim 7, wherein
the money transport cassette includes:
a second connection unit coupled to the first connection unit to be connected to the money handling apparatus, when the money transport cassette is attached to the money handling apparatus; and
a second memory unit configured to store a second number of connection times showing how many times the second connection unit has been connected to the money handling apparatus.

9. The money handling system according to claim 8, wherein:
the money handling apparatus further includes a reading/writing unit configured to read out the second number of connection times of the money transport cassette, when the money transport cassette is connected to the first connection unit;
the control unit is configured to increase the second number of connection times having been read out by the reading/writing unit; and
the reading/writing unit is configured to rewrite the increased second number of connection times to the second memory unit.

10. The money handling system according to claim 8, wherein:
the second memory unit of the money transport cassette is configured to store the second number of connection times and cassette identification information assigned to the money transport cassette;
the reading/writing unit of the money handling apparatus is configured to read out the second number of connection times and the cassette identification information, when the money transport cassette is connected to the first connecting unit; and
the first memory unit is configured to store the second number of connection times corresponding to the money transport cassette and the cassette identification information corresponding thereto, such that the second number of connection times and the cassette identification information are correlated to each other.

11. The money handling system according to claim 7, further comprising a management apparatus communicably connected to the money handling apparatus, and configured to store the first number of connection times and the second number of connection times.

12. The money handling system according to claim 8, wherein
the money handling apparatus further includes a notification unit configured to notify that, when the first or the second number of connection times reaches a predetermined value, the first or the second number of connection times has reached the predetermined value.

13. The money handling system according to claim 11 configured to notify that, when the first or the second number of connection times reaches a predetermined value, the first or the second number of connection times has reached the predetermined value, to the management apparatus.

14. The money handling system according to claim 8, wherein
if the first or the second number of connection times has reached a predetermined value when the money transport cassette is connected to the first connection unit, the money handling apparatus does not deposit and dispense money to and from the money transport cassette.

15. The money handling system according to claim 8, wherein
the control unit is configured to set an upper limit value of the first or the second number of connection times, or
the money handling system includes a connection-times setting apparatus configured to set an upper limit value of the first or the second number of connection times.

16. A money transport cassette attachable to and detachable from a money handling apparatus in order to transport money so as to deposit the money to the money handling apparatus or to dispense the money from the money handling apparatus, the money transport cassette comprising:
a connection unit to be connected to the money handling apparatus, when the money transport cassette is attached to the money handling apparatus; and
a memory unit configured to store a number of connection times showing how many times the connection unit has been connected to the money handling apparatus.

17. The money transport cassette according to claim 16, wherein
the memory unit is configured to store the number of connection times and cassette identification information assigned to the money transport cassette.

18. A money handling apparatus to which a money transport cassette configured to transport money is attachable or from which the money transport cassette is detachable in order to deposit or dispense money, the money handling apparatus comprising:
a first connection unit configured to connected to the money transport cassette, when the money transport cassette is attached to the money handling apparatus;
a first memory unit configured to store a first number of connection times showing how many times the money transport cassette has been connected to the first connection unit; and
a control unit configured to increase the first number of connection times, when the money transport cassette is connected to the first connection unit.

19. The money handling apparatus according to claim 18, wherein
the money handling apparatus further includes a reading/writing unit configured to read out a second number of connection times showing how many times the money transport cassette has been connected to the money handling apparatus, from a second memory unit disposed on the money transport cassette, when the money transport cassette is connected to the first connection unit;
the control unit is configured to increase the second number of connection times having been read out by the reading/writing unit; and
the reading/writing unit is configured to rewrite the increased second number of connection times to the second memory unit.

20. The money handling apparatus according to claim 19, wherein:
the reading/writing unit is configured to read out the second number of connection times and cassette identification information assigned to the money transport cassette, from the money transport cassette, when the money transport cassette is connected to the first connection unit; and
the first memory unit is configured to store the second number of connection times corresponding to the money transport cassette and the cassette identification information corresponding thereto, such that the second number of connection times and the cassette identification information are correlated to each other.

21. The money handling apparatus according to claim 19, further comprising a notification unit configured to notify that, when the first or the second number of connection times reaches a predetermined value, the first or the second number of connection times has reached the predetermined value.

22. The money handling apparatus according to claim 19 configured not to deposit and dispense money to and from the money transport cassette, if the first or the second number of connection times has reached a predetermined value when the money transport cassette is connected to the first connection unit.

23. The money handling apparatus according to claim 19, wherein
the control unit is configured to set an upper limit value of the first or the second connection times.

24. A banknote handling apparatus comprising:
a housing;
an inlet configured to put a banknote from an outside into the housing;
a transport unit disposed in the housing, and configured to transport, one by one, the banknote having been put into the housing through the inlet;
a recognition unit disposed on the transport unit, and configured to recognize at least an authenticity of the banknote having been put into the housing through the inlet; and
a control unit configured to control the transport unit such that, when the banknote is recognized as not genuine by the recognition unit, the banknote is not returned to the outside of the housing.

25. The banknote handling apparatus according to claim 24, wherein
the control unit is configured to control the transport unit such that, when the banknote is recognized as not genuine by the recognition unit, the transport of the banknote by the transport unit is stopped.

26. The banknote handling apparatus according to claim 24, wherein:
a storing unit configured to store the banknote having been put into the housing through the inlet is disposed in the housing; and
the control unit is configured to control the transport unit such that, when the banknote is recognized as not genuine by the recognition unit, the banknote is transported to the storing unit so as to be stored in the storing unit.

27. The banknote handling apparatus according to claim 26, wherein
the control unit is configured to control the transport unit such that, after the banknote having been recognized as not genuine by the recognition unit has been stored into the storing unit, the transport of the banknote by the transport unit is stopped.

28. The banknote handling apparatus according to claim 24, wherein:
a banknote stop location is provided on a position that is inaccessible from the outside of the housing, the banknote having been recognized as not genuine by the recognition unit is stopped at the banknote stop location; and
the control unit is configured to control the transport unit such that, when the banknote is recognized as not genuine by the recognition unit, the banknote is transported to the banknote stop location.

29. The banknote handling apparatus according to claim 28, wherein:
a plurality of the banknote stop locations are provided, and the control unit includes a stop-location selecting unit configured to select, when the banknote is recognized as not genuine by the recognition unit, one of the banknote stop locations at which the banknote is to be stopped.

30. The banknote handling apparatus according to claim 24, further comprising a notification unit configured to notify that, when the banknote is recognized as not genuine by the recognition unit, the banknote has been recognized as not genuine by the recognition unit.

31. The banknote handling apparatus according to claim 30, wherein
the notification unit is configured to notify a stop position of the banknote having been recognized as not genuine by the recognition unit in the housing and/or recognized information of the banknote recognized by the recognition unit.

32. The banknote handling apparatus according to claim 30 or 31, further comprising an operation unit configured to, when the notification unit notifies that the banknote has been recognized as not genuine by the recognition unit, input as to whether the banknote is taken into the housing or not.

33. The banknote handling apparatus according to claim 24, wherein
the inlet is configured to also function as an outlet configured to dispense the banknote from the inside of the housing to the outside thereof.

34. The banknote handling apparatus according to claim 24, wherein
an outlet configured to dispense the banknote from the inside of the housing to the outside thereof is provided separately from the inlet.

35. The banknote handling apparatus according claim 24, wherein the
the banknote handling apparatus is a manned change machine, an unmanned change machine or a back office machine.

36. A banknote handling method comprising:
putting a banknote from an outside of a housing to an inside thereof; and
recognizing at least an authenticity of the banknote having been put into the housing,
wherein, when the banknote is recognized as not genuine in recognizing at least the authenticity of the banknote, the banknote is not returned to the outside of the housing.

37. The banknote handling method according to claim 36, wherein
when the banknote is recognized as not genuine in recognizing at least the authenticity of the banknote, transport of the banknote in the housing is stopped.

38. The banknote handling method according to claim 36, wherein
when the banknote is recognized as not genuine in recognizing at least the authenticity of the banknote, the banknote is transported to a storing unit disposed in the housing so as to be stored into the storing unit.

39. The banknote handling method according to claim 38, wherein
after the banknote having been recognized as not genuine has been stored into the storing unit, the transport of the banknote in the housing is stopped.

40. The money handling machine according to claim 2 wherein:
the position correcting unit is configured to align a plurality of banknotes having been put into the depositing unit, such that the both side edges of the banknotes substantially conform to each other, when the banknotes having been put into the depositing unit are viewed from above surfaces thereof.

41. The money handling apparatus according to claim 2, wherein
the position correcting unit includes:
at least one guide being movable substantially perpendicular to the transport direction of the transport unit, in a horizontal plane with respect to a surface of the banknote having been put into the depositing unit;
a drive source configured to move the guide such that the guide elastically pushes the side edge of the banknote; and
a transmission mechanism configured to transmit a drive force of the drive source to the guide through an elastic member.

42. The money handling apparatus according to claim 3, wherein
the position correcting unit includes:
at least one guide being movable substantially perpendicular to the transport direction of the transport unit, in a horizontal plane with respect to a surface of the banknote having been put into the depositing unit;
a drive source configured to move the guide such that the guide elastically pushes the side edge of the banknote; and
a transmission mechanism configured to transmit a drive force of the drive source to the guide through an elastic member.

43. The money handling apparatus according to claim 2, wherein
the depositing unit includes a sensor configured to detect the banknote having been put thereinto or dispensed; and
the position correcting unit is configured, when the sensor detects the banknote, to correct a position of the banknote.

44. The money handling apparatus according to claim 3, wherein
the depositing unit includes a sensor configured to detect the banknote having been put thereinto or dispensed; and
the position correcting unit is configured, when the sensor detects the banknote, to correct a position of the banknote.
